(19) United States
(12) Patent Application Publication
(10) Pub. No.: US 2023/0267746 A1
(43) Pub. Date: Aug. 24, 2023

(54) INFORMATION PROCESSING DEVICE, INFORMATION PROCESSING METHOD, AND PROGRAM

(71) Applicant: SONY SEMICONDUCTOR SOLUTIONS CORPORATION, KANAGAWA (JP)

(72) Inventor: HIROSHI ICHIKI, KANAGAWA (JP)

(21) Appl. No.: 18/005,358

(22) PCT Filed: Jul. 7, 2021
(86) PCT No.: PCT/JP2021/025620

§ 371 Date: Jan. 13, 2023

(30) Foreign Application Priority Data
Jul. 21, 2020 (JP) 2020-124714

(51) Int. Cl. G06V 20/56; G06T 17/00; G06T 7/62; G06T 7/70; G06V 10/25; G06V 10/74; G06V 10/764

(52) U.S. Cl. CPC G06V 20/56; G06T 17/00; G06T 7/62; G06T 7/70; G06V 10/25; G06V 10/761; G06V 10/764; G06V 2201/07; G06T 2207/30242

(57) ABSTRACT

The present technology relates to an information processing device, an information processing method, and a program capable of reducing a load of object recognition using sensor fusion. The information processing device includes an object region detection unit that detects an object region indicating ranges in an azimuth direction and an elevation angle direction in which there is an object within a sensing range of the distance measurement sensor on the basis of three-dimensional data indicating a direction of and a distance to each measurement point measured by a distance measurement sensor, and associates information within a captured image captured by a camera whose imaging range at least partially overlaps the sensing range with the object region. This technology can be applied, for example, to a system that performs object recognition.

### TECHNICAL FIELD

The present technology relates to an information processing device, an information processing method, and a program, and more particularly, to an information processing device, an information processing method, and a program suitable for use in object recognition using sensor fusion.

### BACKGROUND ART

In recent years, there has been active development of a technology for recognizing objects around a vehicle by using a sensor fusion technology for obtaining new information by combining a plurality of types of sensors such as cameras and light detection and ranging (LiDAR or laser radar) (see, for example, PTL 1).

### CITATION LIST

### Patent Literature

[PTL 1]

JP 2005-284471A

### SUMMARY

### Technical Problem

However, when sensor fusion is used, it is necessary to process data of a plurality of sensors, which increases a load on object recognition. For example, a load of processing for associating each measurement point of point cloud data acquired by LiDAR with a position in a captured image captured by a camera increases.

The present technology has been made in view of such circumstances, and is intended to reduce a load of object recognition using sensor fusion.

### Solution to Problem

An information processing device according to an aspect of the present technology includes an object region detection unit configured to detect an object region indicating ranges in an azimuth direction and an elevation angle direction in which there is an object within a sensing range of the distance measurement sensor on the basis of three-dimensional data indicating a direction of and a distance to each measurement point measured by a distance measurement sensor, and associate information within a captured image captured by a camera whose imaging range at least partially overlaps the sensing range with the object region.

An information processing method according to an aspect of the present technology includes detecting an object region indicating ranges in an azimuth direction and an elevation angle direction in which there is an object within a sensing range of a distance measurement sensor on the basis of three-dimensional data indicating a direction of and a distance to each measurement point measured by the distance measurement sensor and associating information within a captured image captured by a camera whose imaging range at least partially overlaps the sensing range with the object region.

A program according to an aspect of the present technology causes a computer to execute processing for: detecting an object region indicating ranges in an azimuth direction and an elevation angle direction in which there is an object within a sensing range of a distance measurement sensor on the basis of three-dimensional data indicating a direction of and a distance to each measurement point measured by the distance measurement sensor, and associating information within a captured image captured by a camera whose imaging range at least partially overlaps the sensing range with the object region.

In the aspect of the present technology, the object region indicating the ranges in the azimuth direction and the elevation angle direction in which there is the object within the sensing range of the distance measurement sensor is detected on the basis of the three-dimensional data indicating the direction of and the distance to each measurement point measured by the distance measurement sensor, and the information within the captured image captured by the camera whose imaging range at least partially overlaps the sensing range is associated with the object region.

### BRIEF DESCRIPTION OF DRAWINGS

FIG. 1 is a block diagram illustrating a configuration example of a vehicle control system.

FIG. 2 is a diagram illustrating an example of a sensing region.

FIG. 3 is a block diagram illustrating an embodiment of an information processing system to which the present technology is applied.

FIG. 4 is a diagram for comparing methods of associating point cloud data with a captured image.

FIG. 5 is a flowchart illustrating object recognition processing.

FIG. 6 is a diagram illustrating an example of a sensing range in an attachment angle and an elevation angle direction of LiDAR.

FIG. 7 is a diagram illustrating an example in which point cloud data is changed to an image.

FIG. 8 is a diagram illustrating an example of point cloud data when scanning is performed at equal intervals in an elevation angle direction by the LiDAR.

FIG. 9 is a graph illustrating a first example of a scanning method of the LiDAR of the present technology.

FIG. 10 is a diagram illustrating an example of point cloud data generated by using the first example of the scanning method of the LiDAR of the present technology.

FIG. 11 is a diagram illustrating an example of point cloud data generated by using a second example of the scanning method of the LiDAR of the present technology.

FIG. 12 is a schematic diagram illustrating examples of a virtual plane, a unit region, and an object region.

FIG. 13 is a diagram illustrating a method of detecting an object region.

FIG. 14 is a diagram illustrating a method of detecting an object region.

FIG. 15 is a schematic diagram illustrating an example in which a captured image and an object region are associated with each other.

FIG. 16 is a schematic diagram illustrating an example in which a captured image and an object region are associated with each other.

FIG. 17 is a diagram illustrating an example of a result of detecting an object region when an upper limit of the number of detected object regions in the unit region is set to 4.

FIG. 18 is a schematic diagram illustrating an example of a captured image.

FIG. 19 is schematic diagrams illustrating an example in which the captured image and an object region are associated with each other.

FIG. 20 is schematic diagrams illustrating an example of a detection result for a target object region.

FIG. 21 is a schematic diagram illustrating an example of a recognition range.

FIG. 22 is a schematic diagram illustrating an example of an object recognition result.

FIG. 23 is a schematic diagram illustrating a first example of output information.

FIG. 24 is a diagram illustrating a second example of the output information.

FIG. 25 is a schematic diagram illustrating a third example of the output information.

FIG. 26 is a schematic diagram illustrating an example of the captured image and a recognition range.

FIG. 27 is a graph illustrating a relationship between the number of lines of the captured image included in the recognition range and a processing time required for object recognition.

FIG. 28 is a schematic diagram illustrating an example of setting a plurality of recognition ranges.

FIG. 29 is a block diagram illustrating a configuration example of a computer.

### DESCRIPTION OF EMBODIMENTS

Hereinafter, embodiments for implementing the present technology will be described. The description is given in the following order.

### 1. Example of Configuration of Vehicle Control System

### 2. Embodiments

### 3. Modification Example

### 4. Others

### 1. Example of Configuration of Vehicle Control System

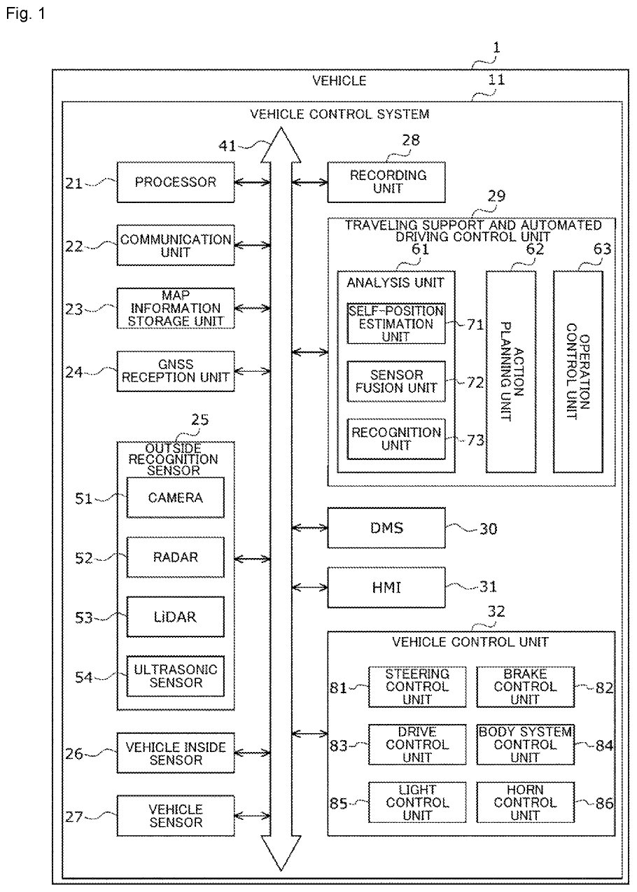

FIG. 1 is a block diagram illustrating a configuration example of a vehicle control system 11, which is an example of a mobile device control system to which the present technology is applied.

The vehicle control system 11 is provided in the vehicle 1 and performs processing regarding traveling support and automated driving of the vehicle 1.

The vehicle control system 11 includes a processor 21, a communication unit 22, a map information accumulation unit 23, a global navigation satellite system (GNSS) reception unit 24, an outside recognition sensor 25, a vehicle inside sensor 26, a vehicle sensor 27, a recording unit 28, a traveling support and automated driving control unit 29, a driver monitoring system (DMS) 30, a human machine interface (HMI) 31, and a vehicle control unit 32.

The processor 21, the communication unit 22, the map information accumulation unit 23, the GNSS reception unit 24, the outside recognition sensor 25, the vehicle inside sensor 26, the vehicle sensor 27, the recording unit 28, the traveling support and automated driving control unit 29, the driver monitoring system (DMS) 30, the human machine interface (HMI) 31, and the vehicle control unit 32 are interconnected via a communication network 41. The communication network 41 is configured of an in-vehicle communication network conforming to any standard such as a controller area network (CAN), a local interconnect network (LIN), a local area network (LAN), FlexRay (registered trademark), or Ethernet (registered trademark), or a bus. Each unit of the vehicle control system 11 may be directly connected by, for example, near field communication (NFC), Bluetooth (registered trademark), or the like, not via the communication network 41.

Hereinafter, when each unit of the vehicle control system 11 communicates via the communication network 41, the description of the communication network 41 is omitted. For example, when the processor 21 and the communication unit 22 perform communication via the communication network 41, it is simply described that the processor 21 and the communication unit 22 perform the communication.

The processor 21 is configured of various processors such as a central processing unit (CPU), a micro processing unit (MPU), and an electronic control unit (ECU). The processor 21 performs control of the entire vehicle control system 11.

The communication unit 22 performs communication with various devices inside and outside the vehicle, other vehicles, servers, base stations, or the like and performs transmission and reception of various types of data. As the communication with the outside of the vehicle, for example, the communication unit 22 receives a program for updating software that controls an operation of the vehicle control system 11, map information, traffic information, information on surroundings of the vehicle 1, or the like from the outside. For example, the communication unit 22 transmits information on the vehicle 1 (for example, data indicating a state of the vehicle 1, and a recognition result of a recognition unit 73), information on the surroundings of the vehicle 1, and the like to the outside. For example, the communication unit 22 performs communication corresponding to a vehicle emergency call system such as e-call.

A communication scheme of the communication unit 22 is not particularly limited. Further, a plurality of communication schemes may be used.

As communication with the inside of the vehicle, for example, the communication unit 22 performs wireless communication with a device in the vehicle using a communication scheme such as wireless LAN, Bluetooth, NFC, or wireless USB (WUSB). For example, the communication unit 22 performs wired communication with a device in the vehicle using a communication scheme such as Universal Serial Bus (USB), High-Definition Multimedia Interface (HDMI; registered trademark), or mobile high-definition link (MHL) via a connection terminal (and a cable when necessary) (not illustrated).

Here, the device in the vehicle is, for example, a device that is not connected to the communication network 41 in the vehicle. For example, a mobile device or wearable device possessed by a passenger such as the driver, an information device brought into a vehicle and temporarily installed, and the like are assumed.

For example, the communication unit 22 performs communication with, for example, a server existing on an external network (for example, the Internet, a cloud network, or a network owned by a business) via a base station or an access point using a wireless communication scheme such as a fourth generation mobile communication system (4G), a fifth generation mobile communication system (5G), long term evolution (LTE), or dedicated short range communications (DSRC).

For example, the communication unit 22 performs communication with a terminal (for example, a terminal of a pedestrian or a store, or a machine type communication (MTC) terminal) near the own vehicle using a peer to peer (P2P) technology. For example, the communication unit 22 performs V2X communication. The V2X communication is, for example, vehicle to vehicle communication with another vehicle, vehicle to infrastructure communication with a roadside device or the like, vehicle to home communication with home, or vehicle to pedestrian communication with a terminal or the like possessed by a pedestrian.

For example, the communication unit 22 receives electromagnetic waves transmitted by a Vehicle Information and Communication System (VICS; registered trademark) such as a radio wave beacon, optical beacon, or FM multiplex broadcasting.

The map information accumulation unit 23 accumulates maps acquired from the outside and maps created by the vehicle 1. For example, the map information accumulation unit 23 accumulates a three-dimensional high-precision map, a global map covering a wide region, which is lower in accuracy than the high-precision map, and the like.

The high-precision map is, for example, a dynamic map, a point cloud map, or a vector map (also called an Advanced Driver Assistance System (ADAS) map). The dynamic map is, for example, a map consisting of four layers including dynamic information, semi-dynamic information, semi-static information, and static information, and is provided from an external server or the like. The point cloud map is a map consisting of a point cloud (point cloud data). The vector map is a map in which information such as positions of lanes or signals are associated with a point cloud map. The point cloud map and the vector map, for example, may be provided from an external server or the like, or may be created by the vehicle 1 as a map for performing matching with a local map to be described below on the basis of a sensing result of the radar 52, LiDAR 53, or the like and accumulated in the map information accumulation unit 23. Further, when the high-precision map is provided from the external server or the like, map data of, for example, hundreds of meters square regarding a planned path along which the vehicle 1 will travel from now on is acquired from the server or the like in order to reduce a communication capacity.

The GNSS reception unit 24 receives a GNSS signal from a GNSS satellite and supplies the GNSS signal to the traveling support and automated driving control unit 29.

The outside recognition sensor 25 includes various sensors used for recognition of a situation of the outside of the vehicle 1, and supplies sensor data from each sensor to each unit of the vehicle control system 11. A type or number of sensors included in the outside recognition sensor 25 are arbitrary.

For example, the outside recognition sensor 25 includes a camera 51, a radar 52, a LiDAR (Light Detection and Ranging, Laser Imaging Detection and Ranging) 53 and an ultrasonic sensor 54. The number of cameras 51, radars 52, LiDARs 53, and ultrasonic sensors 54 is arbitrary, and examples of sensing regions of the respective sensors will be described below.

For the camera 51, for example, any photographing type of camera such as a time of flight (ToF) camera, a stereo camera, a monocular camera, or an infrared camera may be used as necessary.

Further, for example, the outside recognition sensor 25 includes an environment sensor for detecting weather, climate, brightness, and the like. The environmental sensor includes, for example, a raindrop sensor, a fog sensor, a sunlight sensor, a snow sensor, and an illuminance sensor.

Further, for example, the outside recognition sensor 25 includes a microphone used for detection of sounds around the vehicle 1 or a position of a sound source.

The vehicle inside sensor 26 includes various sensors for detecting information on the inside of the vehicle, and supplies sensor data from each sensor to each unit of the vehicle control system 11. A type and number of sensors included in the vehicle inside sensor 26 are arbitrary.

For example, the vehicle inside sensor 26 includes a camera, a radar, a seating sensor, a steering wheel sensor, a microphone, a biosensor, and the like. For the camera, for example, any photographing type of camera such as a ToF camera, a stereo camera, a monocular camera, or an infrared camera may be used. The biosensor is provided, for example, in a seat or a steering wheel, and detects various types of biological information of a passenger such as a driver.

The vehicle sensor 27 includes various sensors for detecting the state of the vehicle 1 and supplies sensor data from each sensor to each unit of the vehicle control system 11. A type and number of sensors included in the vehicle sensor 27 are arbitrary.

For example, the vehicle sensor 27 includes a speed sensor, an acceleration sensor, an angular velocity sensor (a gyro sensor), and an inertial measurement unit (IMU). For example, the vehicle sensor 27 includes a steering angle sensor that detects a steering angle of the steering wheel, a yaw rate sensor, an accelerator sensor that detects an amount of operation of an accelerator pedal, and a brake sensor that detects an amount of operation of a brake pedal. For example, the vehicle sensor 27 includes a rotation sensor that detects the number of rotations of an engine or a motor, an air pressure sensor that detects air pressure of a tire, a slip rate sensor that detects a slip rate of the tire, and a wheel speed sensor that detects a rotational speed of a vehicle wheel. For example, the vehicle sensor 27 includes a battery sensor that detects a remaining level and temperature of a battery, and an impact sensor that detects external impact.

Examples of the recording unit 28 include a magnetic storage device such as a read only memory (ROM), a random access memory (RAM), or a hard disc drive (HDD), a semiconductor storage device, an optical storage device, and a magneto-optical storage device. The recording unit 28 records various programs or data used by each unit of the vehicle control system 11. For example, the recording unit 28 records a rosbag file including messages transmitted or received by a robot operating system (ROS) on which an application program related to automated driving operates. For example, the recording unit 28 includes an event data recorder (EDR) or a data storage system for automated driving (DSSAD), and records information on the vehicle 1 before and after an event such as an accident.

The traveling support and automated driving control unit 29 performs control of traveling support and automated driving of the vehicle 1. For example, the traveling support and automated driving control unit 29 includes an analysis unit 61, an action planning unit 62, and an operation control unit 63.

The analysis unit 61 performs analysis processing on situations of the vehicle 1 and surroundings of the vehicle 1. The analysis unit 61 includes a self-position estimation unit 71, a sensor fusion unit 72, and the recognition unit 73.

The self-position estimation unit 71 estimates the self-position of the vehicle 1 on the basis of the sensor data from the outside recognition sensor 25 and the high-precision map accumulated in the map information accumulation unit 23. For example, the self-position estimation unit 71 generates the local map on the basis of the sensor data from the outside recognition sensor 25, and performs matching between the local map and the high-precision map to estimate the self-position of the vehicle 1. For the position of the vehicle 1, for example, a center of a rear wheel pair shaft is used for a reference.

The local map is, for example, a three-dimensional high-precision map created using a technique such as simultaneous localization and mapping (SLAM), or an occupancy grid map. The three-dimensional high-precision map is, for example, the point cloud map described above. The occupancy grid map is a map in which a three-dimensional or two-dimensional space around the vehicle 1 is divided into grids (lattice) having a predetermined size and an occupied state of object is shown on the grid basis. The occupied state of the object is indicated, for example, by the presence or absence of an object and a probability of the presence. The local map is also used, for example, for detection processing and recognition processing of a situation outside the vehicle 1 in the recognition unit 73.

The self-position estimation unit 71 may estimate the self-position of the vehicle 1 on the basis of the GNSS signal and the sensor data from the vehicle sensor 27.

The sensor fusion unit 72 combines a plurality of different types of sensor data (for example, image data supplied from the camera 51 and sensor data supplied from the radar 52) and performs sensor fusion processing to obtain new information. Methods for combining different types of sensor data include integration, fusion, federation, and the like.

The recognition unit 73 performs detection processing and recognition processing for the situation of the outside of the vehicle 1.

For example, the recognition unit 73 performs the detection processing and recognition processing for the situation of the outside of the vehicle 1 on the basis of information from the outside recognition sensor 25, information from the self-position estimation unit 71, information from the sensor fusion unit 72, and the like.

Specifically, for example, the recognition unit 73 performs detection processing, recognition processing, and the like for the object around the vehicle 1. The object detection processing is, for example, processing for detecting the presence or absence, size, shape, position, motion, and the like of the object. The object recognition processing is, for example, processing for recognizing an attribute such as a type of the object or identifying a specific object. However, the detection processing and the recognition processing are not always clearly separated, and may overlap.

For example, the recognition unit 73 detects the object around the vehicle 1 by performing clustering to classify point clouds based on sensor data of a LiDAR, radar, or the like into clusters of point groups. Accordingly, presence or absence, size, shape, and position of the object around the vehicle 1 are detected.

For example, the recognition unit 73 detects a motion of the object around the vehicle 1 by performing tracking to track a motion of a cluster of point clouds classified by clustering. Accordingly, a speed and traveling direction (a motion vector) of the object around the vehicle 1 are detected.

For example, the recognition unit 73 recognizes a type of the object around the vehicle 1 by performing object recognition processing such as semantic segmentation on image data supplied from the camera 51.

Examples of an object as a detection or recognition target include vehicles, people, bicycles, obstacles, structures, roads, traffic lights, traffic signs, and road markings.

For example, the recognition unit 73 performs recognition processing on a traffic rule for surroundings of the vehicle 1 on the basis of the map accumulated in the map information accumulation unit 23, a self-position estimation result, and a recognition result for the object around the vehicle 1. Through this processing, for example, a position and state of traffic signals, content of the traffic signs and the road markings, content of traffic restrictions, and lanes in which the vehicle can travel are recognized.

For example, the recognition unit 73 performs recognition processing for an environment around the vehicle 1. As an environment of surroundings as a recognition target, for example, weather, temperature, humidity, brightness, and a state of a road surface are assumed.

The action planning unit 62 creates an action plan for the vehicle 1. For example, the action planning unit 62 creates the action plan by performing global path planning and path tracking processing.

The global path planning is process for planning a rough path from start to a goal. This path planning is called a trajectory planning, and trajectory generation (local path planning) processing that can proceed safely and smoothly near the vehicle 1 in consideration of motion characteristics of the vehicle 1 in a path planned by the path planning is also included.

The path tracking is processing for planning an operation for safely and accurately traveling on the path planned by the path planning within a planned time. For example, a target velocity and a target angular velocity of the vehicle 1 are calculated.

The operation control unit 63 controls an operation of the vehicle 1 in order to realize the action plan created by the action planning unit 62.

For example, the operation control unit 63 controls a steering control unit 81, a brake control unit 82, and a drive control unit 83 to perform acceleration or deceleration control and direction control so that the vehicle 1 travels along the trajectory calculated by a trajectory plan. For example, the operation control unit 63 performs cooperative control aimed at realizing ADAS functions such as collision avoidance or shock mitigation, tracking traveling, vehicle speed maintenance traveling, collision warning for the own vehicle, and lane deviation warning for the own vehicle. For example, the operation control unit 63 performs cooperative control aimed at automated driving in which the vehicle automatedly travels without depending on an operation of a driver.

The DMS 30 performs driver authentication processing, driver state recognition processing, and the like on the basis of sensor data from the vehicle inside sensor 26, input data input to the HMI 31, and the like. As a state of the driver as a recognition target, for example, a physical condition, wakefulness, concentration, fatigue, line of sight direction, drunkenness, driving operation, and posture are assumed.

The DMS 30 may perform processing for authenticating the passenger other than the driver, and processing for recognizing a state of the passenger. Further, for example, the DMS 30 may perform processing for recognizing the situation inside the vehicle on the basis of the sensor data from the vehicle inside sensor 26. The situation inside the vehicle that is a recognition target is assumed to be temperature, humidity, brightness, and smell, for example.

The HMI 31 is used to input various types of data, instructions, or the like, generates an input signal on the basis of the input data, instruction, or the like, and supplies the input signal to each unit of the vehicle control system 11. For example, the HMI 31 includes an operation device such as a touch panel, button, microphone, a switch, or lever, and an operation device capable of inputting using methods other than a manual operation, such as a voice or gesture. The HMI 31 may be, for example, a remote control device using infrared rays or other radio waves, or an externally connected device such as a mobile device or wearable device corresponding to an operation of the vehicle control system 11.

Further, the HMI 31 performs output control for controlling generation and output of visual information, auditory information, and tactile information for the passenger or the outside of the vehicle, output content, output timing, output method, and the like. The visual information is, for example, information indicated by an operation screen, a state display of the vehicle 1, a warning display, an image such as a monitor image showing a situation of surroundings of the vehicle 1, or light. The auditory information is, for example, information indicated by sound, such as a guidance, warning sound, or warning message. The tactile information is, for example, information given to a tactile sense of the passenger by a force, vibration, motion, or the like.

As devices that output the visual information, for example, a display device, a projector, a navigation device, an instrument panel, a camera monitoring system (CMS), an electronic mirror, and a lamp are assumed. The display device may be a device that displays the visual information within a field of view of the passenger, such as a head-up display, a transmissive display, and a wearable device having an augmented reality (AR) function, in addition to a device having a normal display.

As devices that output the auditory information, for example, an audio speaker, a headphone, and an earphone are assumed.

As a device that outputs the tactile information, for example, a haptic element using a haptic technology is assumed. The haptic element is provided, for example, on a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs, for example, detection and control of a state of a steering system of the vehicle 1. The steering system includes, for example, a steering mechanism including a steering wheel, electric power steering, and the like. The steering control unit 81 includes, for example, a control unit such as an ECU that performs control of the steering system, an actuator that performs driving of the steering system, and the like.

The brake control unit 82 performs, for example, detection and control of a state of a brake system of the vehicle 1. The brake system includes, for example, a brake mechanism including a brake pedal, and an antilock brake system (ABS). The brake control unit 82 includes, for example, a control unit such as an ECU that performs control of the brake system, and an actuator that performs driving of the brake system.

The drive control unit 83 performs, for example, detection and control of a state of a drive system of the vehicle 1. The drive system includes, for example, an accelerator pedal, a driving force generation device for generating a driving force such as an internal combustion engine or a driving motor, and a driving force transmission mechanism for transmitting the driving force to wheels. The drive control unit 83 includes, for example, a control unit such as an ECU that performs control of the drive system, and an actuator that performs driving of the drive system.

The body system control unit 84 performs, for example, detection and control of a state of a body system of the vehicle 1. The body system includes, for example, a keyless entry system, a smart key system, a power window device, a power seat, an air conditioner, an air bag, a seat belt, and a shift lever. The body system control unit 84 includes, for example, a control unit such as an ECU that performs control of the body system, and an actuator that performs driving of the body system.

The light control unit 85 performs, for example, detection and control of states of various lights of the vehicle 1. For lights as control targets, for example, headlights, backlights, fog lights, turn signals, brake lights, a projection, and a bumper display are assumed. The light control unit 85 includes a control unit such as an ECU that controls lights, an actuator that performs driving of the lights, and the like.

The horn control unit 86 performs, for example, detection and control of a state of a car horn of the vehicle 1. The horn control unit 86 includes, for example, a control unit such as an ECU that performs control of the car horn, and an actuator that performs driving of the car horn.

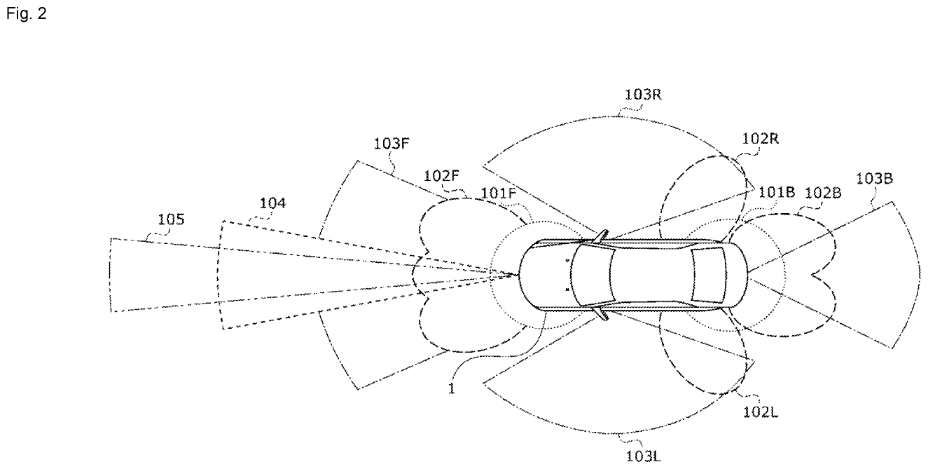

FIG. 2 is a diagram illustrating an example of sensing regions of the camera 51, the radar 52, the LiDAR 53, and the ultrasonic sensor 54 of the outside recognition sensor 25 in FIG. 1.

A sensing region 101F and a sensing region 101B are examples of sensing regions of the ultrasonic sensor 54. The sensing region 101F covers surroundings at a front end of the vehicle 1. The sensing region 101B covers surroundings at a rear end of the vehicle 1.

Sensing results in the sensing region 101F and the sensing region 101B are used for parking assistance of the vehicle 1, for example.

Sensing regions 102F to 102B are examples of sensing regions of the radar 52 for short or medium distances. The sensing region 102F covers up to a position farther than the sensing region 101F in front of the vehicle 1. The sensing region 102B covers up to a position farther from the sensing region 101B behind the vehicle 1. A sensing region 102L covers rear surroundings on the left side of the vehicle 1. The sensing region 102R covers rear surroundings on the right side of the vehicle 1.

The sensing result in the sensing region 102F is used, for example, for detection of a vehicle, a pedestrian, or the like existing in front of the vehicle 1. A sensing result in the sensing region 102B is used, for example, for a function for collision prevention behind the vehicle 1. Sensing results in the sensing region 102L and the sensing region 102R are used, for example, for detection of an object in a blind spot on the side of the vehicle 1.

Sensing regions 103F to 103B are examples of sensing regions of the camera 51. The sensing region 103F covers up to a position farther than the sensing region 102F in front of the vehicle 1. The sensing region 103B covers a position farther than the sensing region 102B behind the vehicle 1. A sensing region 103L covers surroundings a left side surface of the vehicle 1. A sensing region 103R covers surroundings the right side surface of the vehicle 1.

A sensing result in the sensing region 103F is used, for example, for recognition of traffic lights or traffic signs, and a lane deviation prevention support system. A sensing result in the sensing region 103B is used, for example, for parking assistance or a surround view system. Sensing results in the sensing region 103L and the sensing region 103R are used, for example, in a surround view system.

A sensing region 104 is an example of the sensing region of the LiDAR 53. The sensing region 104 covers a position farther than the sensing region 103F in front of the vehicle 1. On the other hand, the sensing region 104 has a narrower range in a lateral direction than the sensing region 103F.

A sensing result in the sensing region 104 is used, for example, for emergency braking, collision avoidance, or pedestrian detection.

A sensing region 105 is an example of a sensing region of a long-range radar 52. The sensing region 105 covers position farther than the sensing region 104 in front of the vehicle 1. On the other hand, the sensing region 105 has a narrower range in a lateral direction than the sensing region 104.

A sensing result in the sensing region 105 is used for adaptive cruise control (ACC), for example.

The sensing region of each sensor may have various configurations other than those illustrated in FIG. 2. Specifically, the ultrasonic sensor 54 may also sense sides of the vehicle 1, and the LiDAR 53 may sense the rear of the vehicle 1.

### 2. Embodiments

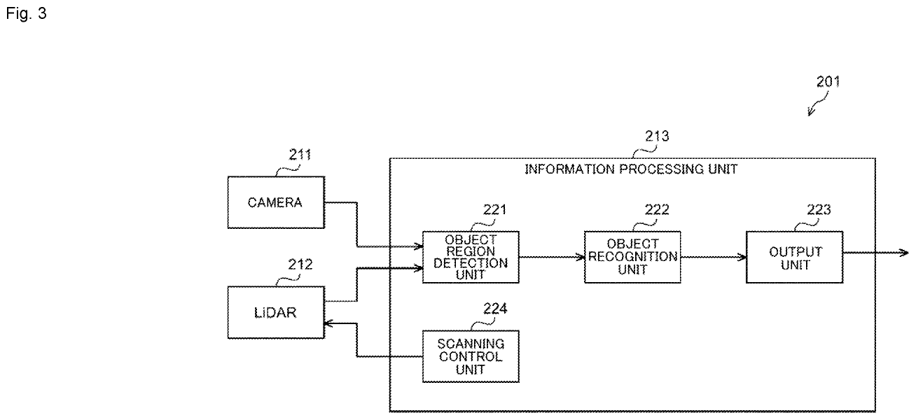

Next, embodiments of the present technology will be described with reference to FIGS. 3 to 27.

<Configuration Example of Information Processing System 201>

FIG. 3 illustrates a configuration example of an information processing system 201 to which the present technology is applied.

The information processing system 201 is, for example, mounted on the vehicle 1 in FIG. 1 and recognizes the object around the vehicle 1.

The information processing system 201 includes a camera 211, a LiDAR 212, and an information processing unit 213.

The camera 211 constitutes, for example, a part of the camera 51 in FIG. 1, images a region in front of the vehicle 1, and supplies an obtained image (hereinafter referred to as a captured image) to the information processing unit 213.

The LiDAR 212 constitutes, for example, a part of the LiDAR 53 in FIG. 1, and performs sensing in the region in front of the vehicle 1, and at least part of the sensing range overlaps an imaging range of the camera 211. For example, the LiDAR 212 scans a region in front of the vehicle 1 with laser pulses, which is measurement light, in an azimuth direction (a horizontal direction) and an elevation angle direction (a height direction), and receives reflected light of the laser pulses. The LiDAR 212 calculates a direction and distance of a measurement point, which is a reflection point on the object that reflects the laser pulses, on the basis of a scanning direction of the laser pulses and a time required for reception of the reflected light. The LiDAR 212 generates point cloud data (point cloud), which is three-dimensional data indicating the direction and distance of each measurement point on the basis of a calculated result. The LiDAR 212 supplies the point cloud data to the information processing unit 213.

Here, the azimuth direction is a direction corresponding to a width direction (a lateral direction or a horizontal direction) of the vehicle 1. The elevation angle direction is a direction perpendicular to a traveling direction (a distance direction) of the vehicle 1 and corresponding to a height direction (a longitudinal direction, vertical direction) of the vehicle 1.

The information processing unit 213 includes an object region detection unit 221, an object recognition unit 222, an output unit 223, and a scanning control unit 224. The information processing unit 213 constitutes, for example, some of the vehicle control unit 32, the sensor fusion unit 72, and the recognition unit 73 in FIG. 1.

The object region detection unit 221 detects a region in front of the vehicle 1 in which an object is likely to exist (hereinafter referred to as an object region) on the basis of the point cloud data. The object region detection unit 221 associates the detected object region with information in the captured image (for example, a region within the captured image). The object region detection unit 221 supplies the captured image, point cloud data, and information indicating a result of detecting the object region to the object recognition unit 222.

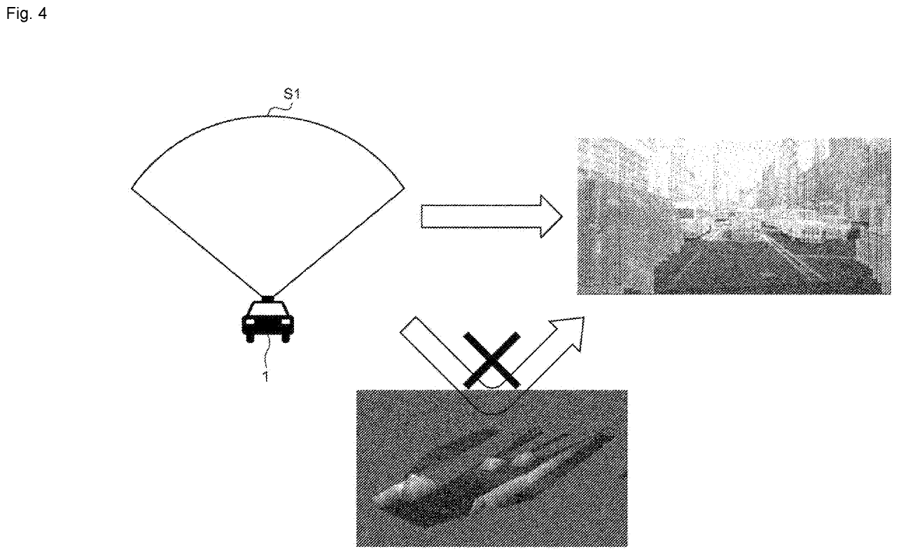

Normally, as illustrated in FIG. 4, point cloud data obtained by sensing a sensing range S1 in front of the vehicle 1 is converted to three-dimensional data in a world coordinate system shown in a lower part of FIG. 4 and then, each measurement point of the point cloud data is associated with a corresponding position within the captured image.

On the other hand, the object region detection unit 221 detects an object region indicating a range in the azimuth direction and the elevation angle direction in which an object is likely to exist in the sensing range S1, on the basis of the point cloud data. More specifically, as will be described below, the object region detection unit 221 detects an object region indicating a range in the elevation angle direction in which an object is likely to be present, in each strip-shaped unit region that is a vertically long rectangle obtained by dividing the sensing range S1 in the azimuth direction, on the basis of the point cloud data. The object region detection unit 221 associates each unit region with the region within the captured image. This reduces the processing for associating the point cloud data with the captured image.

The object recognition unit 222 recognizes an object in front of the vehicle 1 on the basis of the result of detecting the object region and the captured image. The object recognition unit 222 supplies the captured image, the point cloud data, and information indicating the object region and the object recognition result to the output unit 223.

The output unit 223 generates and outputs output information indicating a result of object recognition and the like.

The scanning control unit 224 performs control of scanning with the laser pulses of the LiDAR 212. For example, the scanning control unit 224 controls the scanning direction, the scanning speed, and the like of the laser pulses of the LiDAR 212.

Hereinafter, scanning with the laser pulses of the LiDAR 212 is also simply referred to as scanning of the LiDAR 212. For example, the scanning direction of the laser pulses of the LiDAR 212 is also simply referred to as the scanning direction of the LiDAR 212.

<Object Recognition Processing>

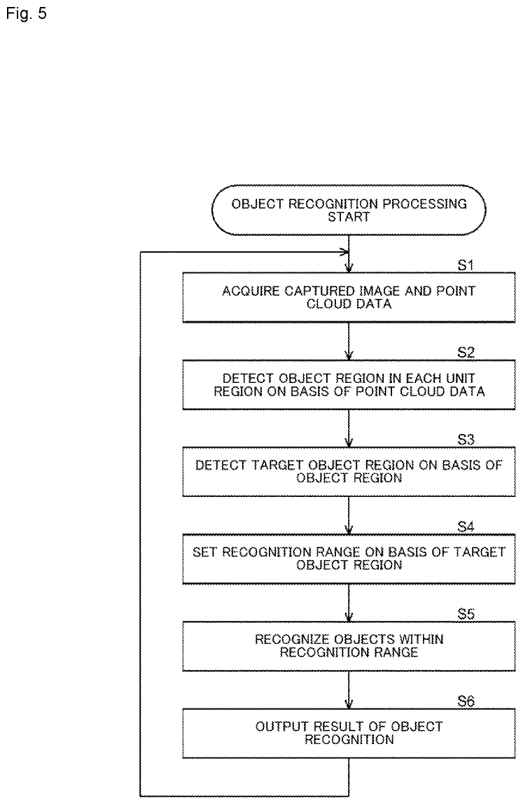

Next, object recognition processing executed by the information processing system 201 will be described with reference to a flowchart of FIG. 5.

This processing is started, for example, when an operation is performed to start up the vehicle 1 and start driving, such as when an ignition switch, a power switch, a start switch, or the like of the vehicle 1 is turned on. Further, this processing ends when an operation for ending driving of the vehicle 1 is performed, such as when an ignition switch, a power switch, a start switch, or the like of the vehicle 1 is turned off.

In step S1, the information processing system 201 acquires the captured image and the point cloud data.

Specifically, the camera 211 images the front of the vehicle 1 and supplies an obtained captured image to the object region detection unit 221 of the information processing unit 213.

Under the control of the scanning control unit 224, the LiDAR 212 scans the region in front of the vehicle 1 with the laser pulses in the azimuth direction and the elevation angle direction, and receives the reflected light of the laser pulses. The LiDAR 212 calculates a distance to each measurement point in front of the vehicle 1 on the basis of the time required for reception of the reflected light. The LiDAR 212 generates point cloud data indicating the direction (the elevation angle and the azimuth) and distance of each measurement point, and supplies the point cloud data to the object region detection unit 221.

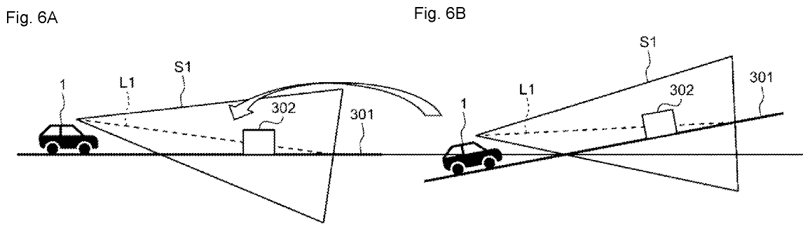

Here, an example of a scanning method of the LiDAR 212 by the scanning control unit 224 will be described with reference to FIGS. 6 to 11.

FIG. 6 illustrates an example of a sensing range at an attachment angle and in an elevation of the LiDAR 212.

As illustrated in A in FIG. 6, the LiDAR 212 is installed on the vehicle 1 with a slight downward tilt. Therefore, a center line L1 in an elevation angle direction of the sensing range S1 is slightly tilted downwards from the horizontal direction with respect to the road surface 301.

Accordingly, as illustrated in B in FIG. 6, a horizontal road surface 301 is viewed as an uphill from the LiDAR 212. That is, in point cloud data of a relative coordinate system (hereinafter referred to as a LiDAR coordinate system) viewed from the LiDAR 212, the road surface 301 looks like an uphill.

On the other hand, usually, after a coordinate system of the point cloud data is converted from the LiDAR coordinate system to an absolute coordinate system (for example, a world coordinate system), road surface estimation is performed on the basis of the point cloud data.

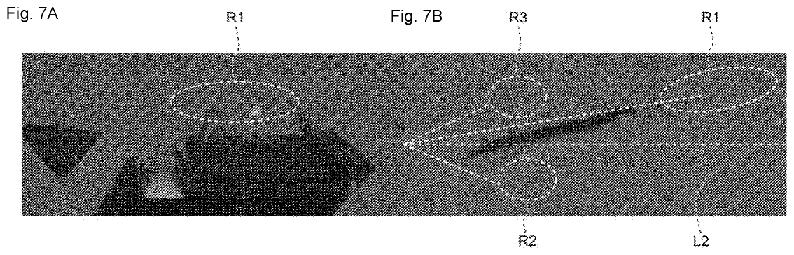

A in FIG. 7 illustrates an example in which the point cloud data acquired by the LiDAR 212 is converted into an image. B of FIG. 7 is a side view of the point cloud data of A in FIG. 7.

A horizontal plane indicated by an auxiliary line L2 in B of FIG. 7 corresponds to the center line L1 of the sensing range S1 in A and B in FIG. 6, and indicates an attachment direction (the attachment angle) of the LiDAR 212. The LiDAR 212 performs scanning with the laser pulses in the elevation angle direction about a horizontal plane 212.

Here, in a case in which scanning is performed with the laser pulses at equal intervals in the elevation angle direction, when the scanning direction of the laser pulses is closer to a direction of the road surface 301, an interval at which the road surface 301 is irradiated with the laser pulses becomes larger. Therefore, when an object 302 (FIG. 6) on the road surface 301 is farther from the vehicle 1, an interval in a distance direction of the laser pulses reflected by the object 302 becomes larger. That is, an interval in the distance direction in which the object 302 can be detected becomes larger. For example, in a distant region R1 in FIG. 7, an interval in the distance direction at which an object can be detected is several meters. Further, when the object 302 is farther from the vehicle 1, a size of the object 302 viewed from the vehicle 1 decreases. Therefore, in order to improve the detection accuracy of a distant object, it is preferable to narrow a scanning interval in the elevation angle direction of the laser pulses when the scanning direction of the laser pulses approaches the direction of the road surface 301.

On the other hand, when an angle (an irradiation angle) at which the road surface 301 is irradiated with the laser pulses increases, an interval in the distance direction at which the road surface is irradiated with the laser pulses becomes smaller, and the interval in the distance direction at which an object can be detected becomes smaller. For example, in a region R2 in FIG. 7, an interval in the distance direction at which the laser pulses are radiated is smaller than in the region R1. Further, when the object is closer to the vehicle 1, the object appears to be larger for the vehicle 1. Therefore, when the irradiation angle of the laser pulses with respect to the road surface 301 increases, the object detection accuracy hardly decreases even when the scanning interval in the elevation angle direction of the laser pulses is increased to some extent.

Further, traffic signals, road signs, information boards, and the like are mainly recognition targets above the vehicle 1, and the risk of the vehicle 1 colliding with these is low. Further, when the scanning direction of the laser pulses is directed upwards, the interval in the distance direction at which an object above the vehicle 1 is irradiated with the laser pulses becomes smaller, and the interval in the distance direction in which the object can be detected becomes smaller. For example, in a region R3 in FIG. 7, the interval in the distance direction at which the laser pulses are radiated becomes smaller than in the region R1. Therefore, when the scanning direction of the laser pulses is directed upwards, the object detection accuracy hardly decreases even when the scanning interval in the elevation angle direction of the laser pulses is increased to some extent.

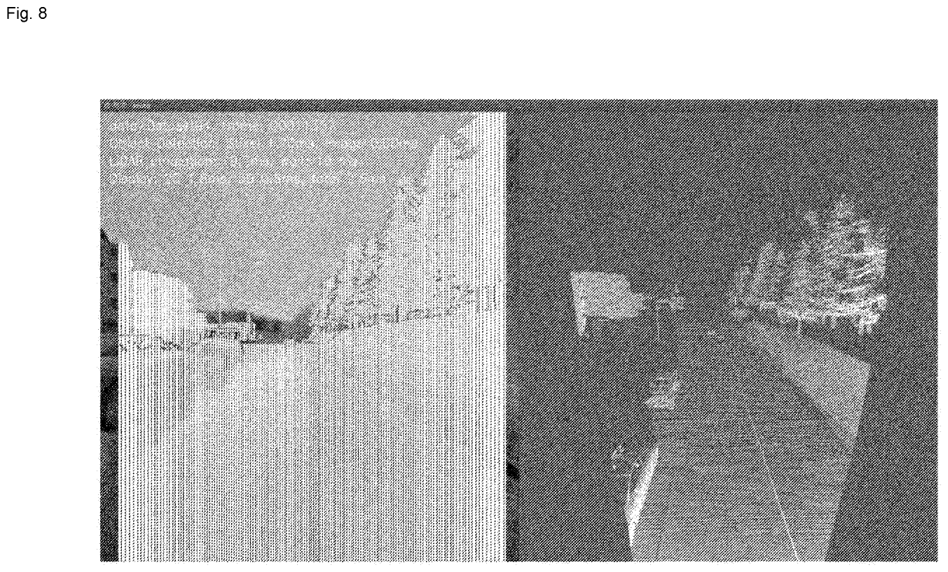

FIG. 8 illustrates an example of the point cloud data when scanning is performed with laser pulses at equal intervals in the elevation angle direction. A right diagram of FIG. 8 illustrates an example in which the point cloud data is converted to an image. A left diagram of FIG. 8 illustrates an example in which each measurement point of the point cloud data is disposed at a corresponding position of the captured image.

As illustrated in this figure, when scanning is performed at equal intervals in the elevation angle direction by the LiDAR 212, the number of measurement points on the road near the vehicle 1 becomes unnecessarily larger. Accordingly, there is concern that a load of processing of the measurement points on the road surface near the vehicle 1 increases, and a delay in object recognition, for example, is likely to occur.

On the other hand, the scanning control unit 224 controls the scanning interval in the elevation angle direction of the LiDAR 212 on the basis of the elevation angle.

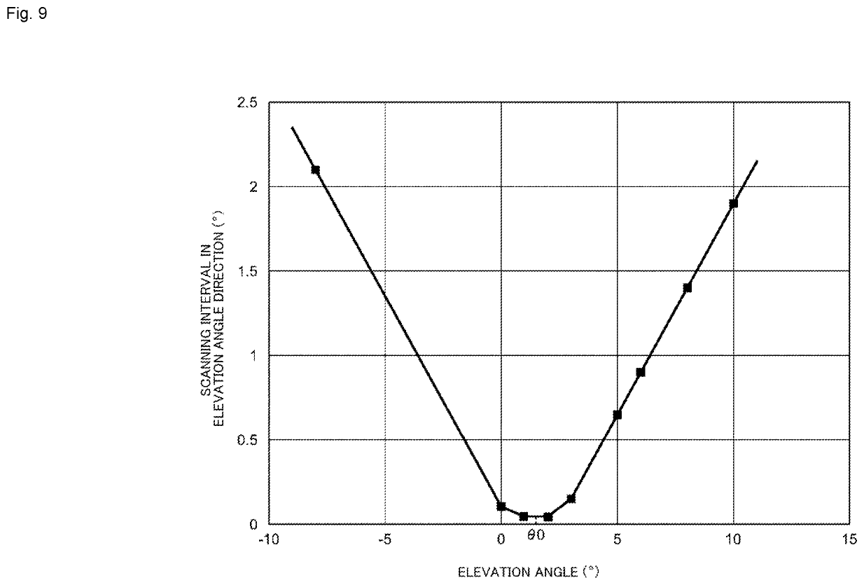

FIG. 9 is a graph illustrating an example of the scanning interval in the elevation angle direction of the LiDAR 212. A horizontal axis of FIG. 9 indicates the elevation angle (in units of degrees), and a vertical axis indicates the scanning interval in the elevation angle direction (in units of degrees).

In this example, the scanning interval in the elevation angle direction of the LiDAR 212 becomes smaller when an angle approaches a predetermined elevation angle θ0, and becomes the shortest at the elevation angle θ0.

The elevation angle θ0 is set according to the attachment angle of the LiDAR 212, and is set to, for example, an angle at which a position a predetermined reference distance away from the vehicle 1 is irradiated with a laser pulse on a horizontal road surface in front of the vehicle 1. The reference distance is set, for example, to a maximum value of a distance at which an object as a recognition target (for example, a preceding vehicle) is desired to be recognized in front of the vehicle 1.

Accordingly, when a region is closer to the reference distance, the scanning interval of the LiDAR 212 becomes smaller, and an interval in the distance direction between the measurement points becomes smaller.

On the other hand, when a region is farther from the reference distance, the scanning interval of the LiDAR 212 increases, and the interval in the distance direction between the measurement points increases. Therefore, the interval in the distance direction between the measurement points on the road surface in front of and near the vehicle 1 or in the region above the vehicle 1 increases.

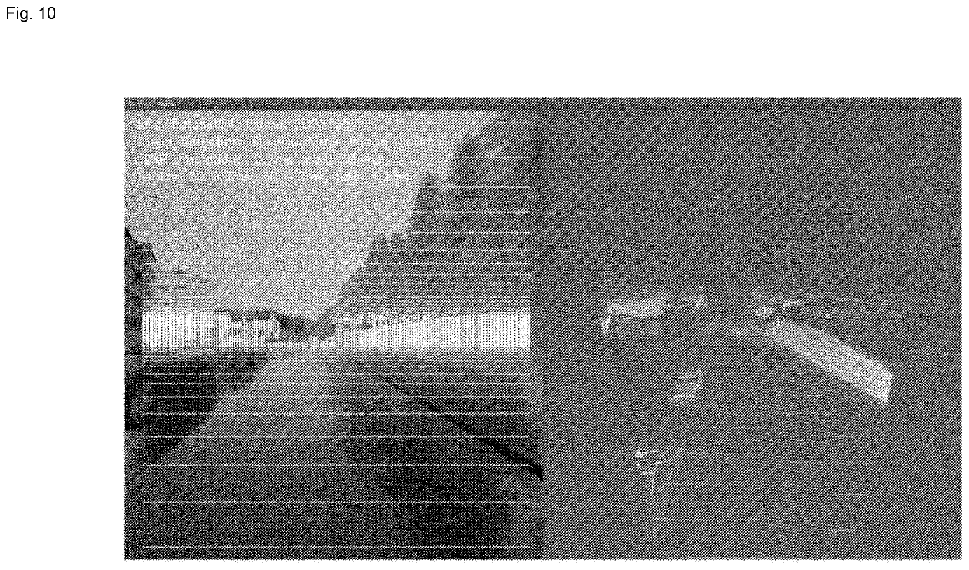

FIG. 10 illustrates an example of the point cloud data when the scanning in the elevation angle direction of the LiDAR 212 is controlled as described above with reference to FIG. 9. A right diagram in FIG. 10 illustrates an example in which the point cloud data is converted to an image, like the right diagram in FIG. 8. A left diagram in FIG. 10 illustrates an example in which each measurement point of the point cloud data is disposed at a corresponding position of the captured image, like the left diagram in FIG. 8.

As illustrated in FIG. 10, the interval in the distance direction between the measurement points becomes smaller in a region approaching a region rea the predetermined reference distance away from the vehicle 1, and becomes larger in a region away from the region the predetermined reference distance away from the vehicle 1. This makes it possible to thin out the measurement points of the LiDAR 212 and reduce an amount of calculation without lowering object recognition accuracy.

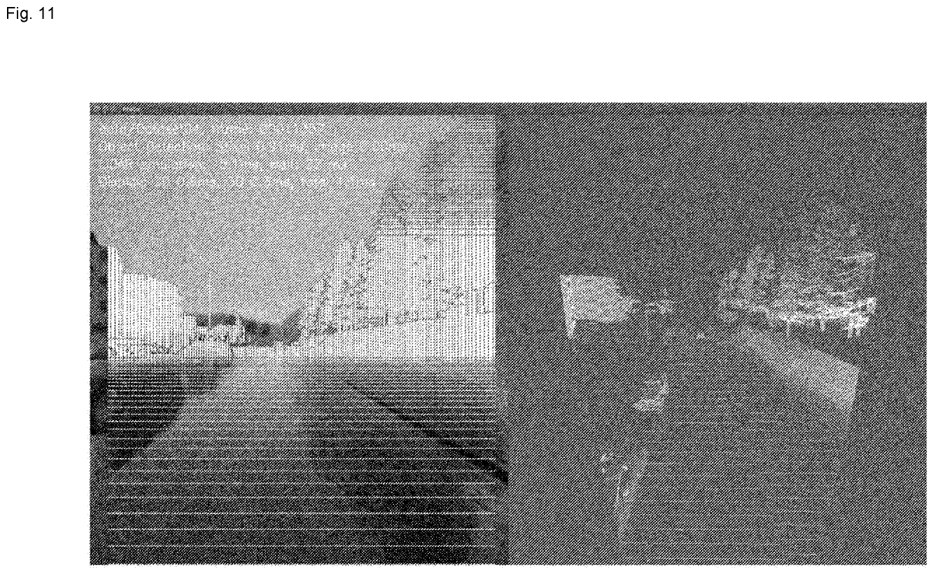

FIG. 11 illustrates a second example of a method for scanning with the LiDAR 212.

A right diagram in FIG. 11 illustrates an example in which the point cloud data is converted into an image, like the right diagram in FIG. 8. A left diagram in FIG. 11 illustrates an example in which each measurement point of the point cloud data is disposed at a corresponding position of the captured image, like the left diagram in FIG. 8.

In this example, the scanning interval in the elevation angle direction of the laser pulses is controlled so that the scanning interval in the distance direction with respect to the horizontal road surface in front of the vehicle 1 is equal. This makes it possible to reduce, particularly, the number of measurement points on the road surface near the vehicle 1, and, for example, to reduce the amount of calculation when estimation of the road surface is performed on the basis of point cloud data.

Returning to FIG. 5, in step S2, the object region detection unit 221 detects an object region in each unit region on the basis of the point cloud data.

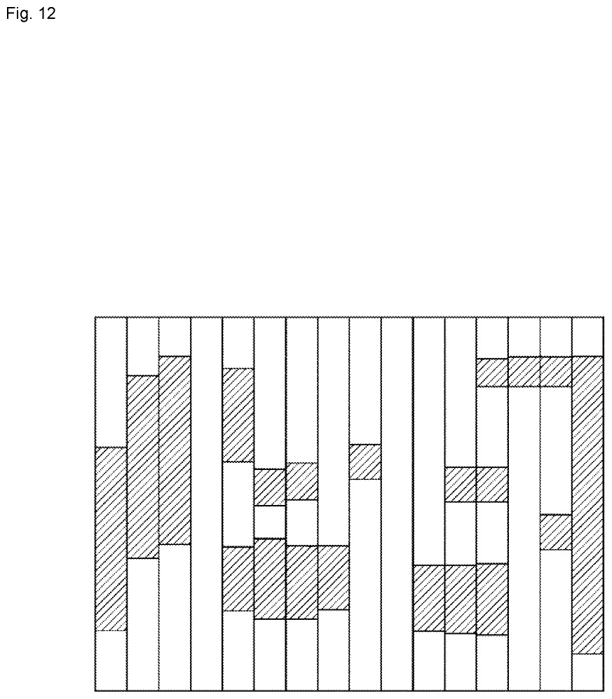

FIG. 12 is a schematic diagram illustrating examples of a virtual plane, the unit region, and the object region.

An outer rectangular frame in FIG. 12 indicates the virtual plane. The virtual plane indicates a sensing range (scanning range) in the azimuth direction and the elevation angle direction of the LiDAR 212. Specifically, a width of the virtual plane indicates the sensing range in the azimuth direction of the LiDAR 212, and a height of the virtual plane indicates the sensing range in the elevation angle direction of the LiDAR 212.

A plurality of vertically long rectangular (strip-shaped) regions obtained by dividing the virtual plane in the azimuth direction indicate unit regions. Here, widths of the respective unit regions may be equal or may be different. In the former case, the virtual plane is divided equally in the azimuth direction and in the latter case, the virtual plane is divided at different angles.

A rectangular region indicated by oblique lines in each unit region indicates the object region. The object region indicates a range in the elevation angle direction in which an object is likely to exist in each unit region.

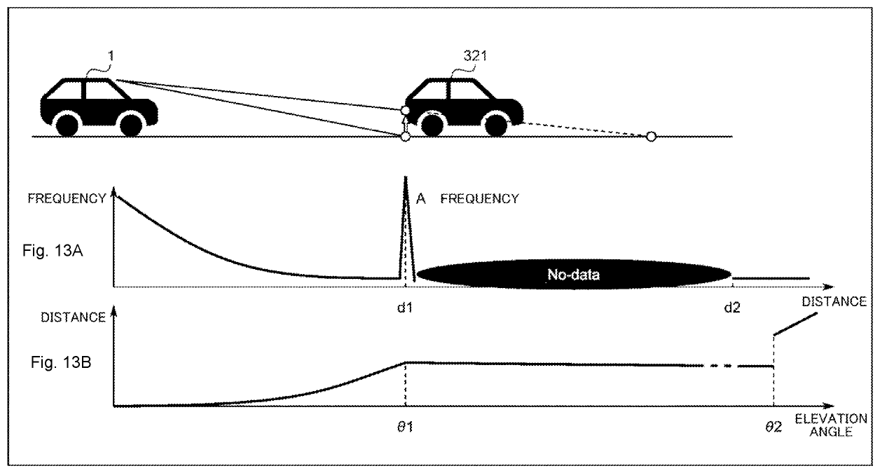

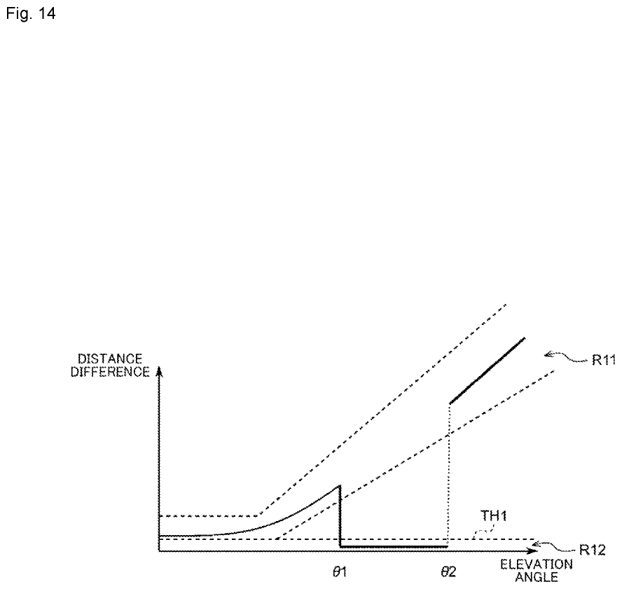

Here, an example of an object region detection method will be described with reference to FIGS. 13 and 14.

FIG. 13 illustrates an example of a distribution of point cloud data within one unit region (that is, within a predetermined azimuth range) when a vehicle 351 exists at a position a distance d1 away in front of the vehicle 1.

A in FIG. 13 illustrates an example of a histogram of distances of measurement points of point cloud data within the unit region. A horizontal axis indicates a distance from the vehicle 1 to each measurement point. A vertical axis indicates the number (frequency) of measurement points present at the distance indicated on the horizontal axis.

B in FIG. 13 illustrates an example of a distribution of elevation angles of and distances to measurement points of the point cloud data within the unit region. A horizontal axis indicates the elevation angle in the scanning direction of the LiDAR 212. Here, a lower end of the sensing range in the elevation angle direction of the LiDAR 212 is 0°, and an upward direction is a positive direction. A vertical axis indicates a distance to the measurement point present in a direction of the elevation angle indicated on the horizontal axis.

As illustrated in A of FIG. 13, the frequency of the distance of the measurement point within the unit region is maximized immediately in front of the vehicle 1 and decreases toward the distance d1 at which there is the vehicle 351. Further, the frequency of the distance of the measurement point in the unit region shows a peak near the distance d1, and becomes substantially 0 between the vicinity of the distance d1 and a distance d2. Further, after the distance d2, the frequency of the distance of the measurement point in the unit region becomes substantially constant at a value smaller than the frequency immediately before the distance d1. The distance d2 is, for example, the shortest distance of the point (measurement point) at which the laser pulses reaches beyond the vehicle 351.

There is no measurement point in a range from the distance d1 to the distance d2. Therefore, it is difficult to determine whether a region corresponding to the range is an occlusion region hidden behind an object (the vehicle 351 in this example) or a region such as the sky in which there is no object.

On the other hand, as illustrated in B in FIG. 13, the distance to the measurement point in the unit region increases when the elevation angle increases in a range of the elevation angle from 0° to angle θ1, and becomes substantially constant at the distance d1 within a range of the elevation angle from the angle θ1 to an angle θ2. The angle θ1 is a minimum value of an elevation angle at which the laser pulses is reflected by the vehicle 351, and the angle θ2 is a maximum value of an elevation angle at which the laser pulses is reflected by the vehicle 351. The distance to the measurement point in the unit region increases when the elevation angle increases in a range of the elevation angle of the angle θ2 or more.

With data of B in FIG. 13, it is possible to rapidly determine that a region corresponding to a range of the elevation angle in which there is no measurement point (a range of the elevation angle in which the distance cannot be measured) is the region such as the sky in which there is no object, unlike the data of A in FIG. 13

The object region detection unit 221 detects the object region on the basis of distributions of the elevation angles of and distances to the measurement points illustrated in B in FIG. 13. Specifically, for each unit region, the object region detection unit 221 differentiates the distribution of the distances to the measurement points in each unit region with respect to the elevation angle. Specifically, for example, the object region detection unit 221 obtains a difference in the distance between adjacent measurement points in the elevation angle direction in each unit region.

FIG. 14 illustrates an example of a result of differentiating the distances to the measurement points with respect to the elevation angle when the distances to the measurement points in the unit region are distributed as illustrated in B in FIG. 13. A horizontal axis indicates the elevation angle, and a vertical axis indicates the difference in distance between adjacent measurement points in the elevation angle direction (hereinafter referred to as distance difference value).

For example, a distance difference value for a road surface on which there is no object is estimated to fall within a range R11. That is, the distance difference value is estimated to increase within a predetermined range when the elevation angle increases.

On the other hand, when there is an object on the road surface, the distance difference value is estimated to fall within a range R12. That is, the distance difference value is estimated to be equal to or smaller than a predetermined threshold value TH1 regardless of the elevation angle.

For example, in the example of FIG. 14, the object region detection unit 221 determines that there is an object within a range in which the elevation angle is from an angle θ1 to an angle θ2. The object region detection unit 221 detects the range of elevation angles from the angle θ1 to the angle θ2 as the object region in the unit region that is a target.

It is preferable to set the number of detectable object regions in each unit region to two or more so that object regions corresponding to different objects can be separated in each unit region. On the other hand, in order to reduce a processing load, it is preferable to set an upper limit of the number of detected object regions in each unit region. For example, the upper limit of the number of detected object regions in each unit region is set within a range of 2 to 4.

Returning to FIG. 5, in step S3, the object region detection unit 221 detects a target object region on the basis of the object region.

First, the object region detection unit 221 associates each object region with the captured image. Specifically, an attachment position and attachment angle of the camera 211 and the attachment position and attachment angle of the LiDAR 212 are known, and a positional relationship between the imaging range of the camera 211 and the sensing range of the LiDAR 212 is known. Therefore, a relative relationship between the virtual plane and each unit region, and the region within the captured image is also known. Using such known information, the object region detection unit 221 calculates the region corresponding to each object region within the captured image on the basis of a position of each object region within the virtual plane, to associate each object region with the captured image.

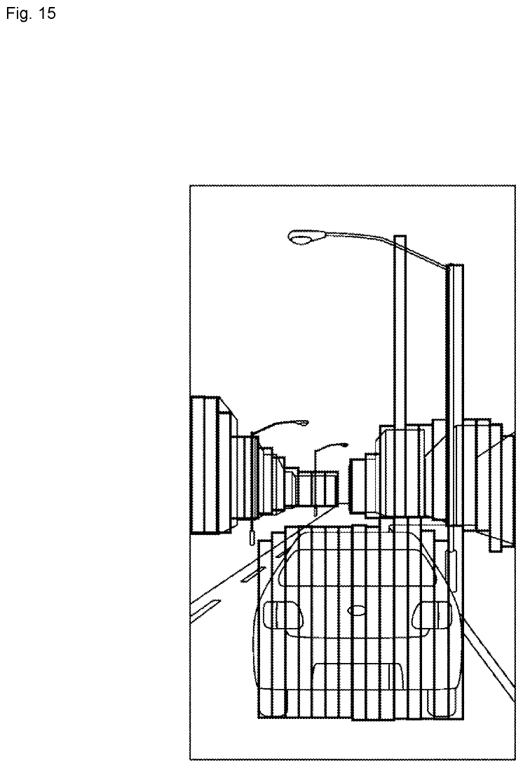

FIG. 15 schematically illustrates an example in which a captured image and object regions are associated with each other. Vertically long rectangular (strip-shaped) regions in the captured image are the object regions.

Thus, each object region is associated with the captured image on the basis of only positions within the virtual plane, regardless of the content of the captured image. Therefore, it is possible to rapidly associate each object region with the region within the captured image with a small amount of calculation.

Further, the object region detection unit 221 converts the coordinates of the measurement point within each object region from the LiDAR coordinate system to a camera coordinate system. That is, the coordinates of the measurement point within each object region are converted from coordinates represented by the azimuth, elevation angle, and distance in the LiDAR coordinate system to coordinates in a horizontal direction (an x-axis direction) and a vertical direction (a y-axis direction) in the camera coordinate system. Further, coordinates in a depth direction (a z-axis direction) of each measurement point are obtained on the basis of a distance to the measurement point in the LiDAR coordinate system.

Next, the object region detection unit 221 performs coupling processing for coupling object regions estimated to correspond to the same object, on the basis of a relative positions between the object regions and the distances to the measurement points included in each object region. For example, the object region detection unit 221 couples adjacent object regions when the difference in distance is within a predetermined threshold value on the basis of the distances of measurement points included in the respective adjacent object regions.

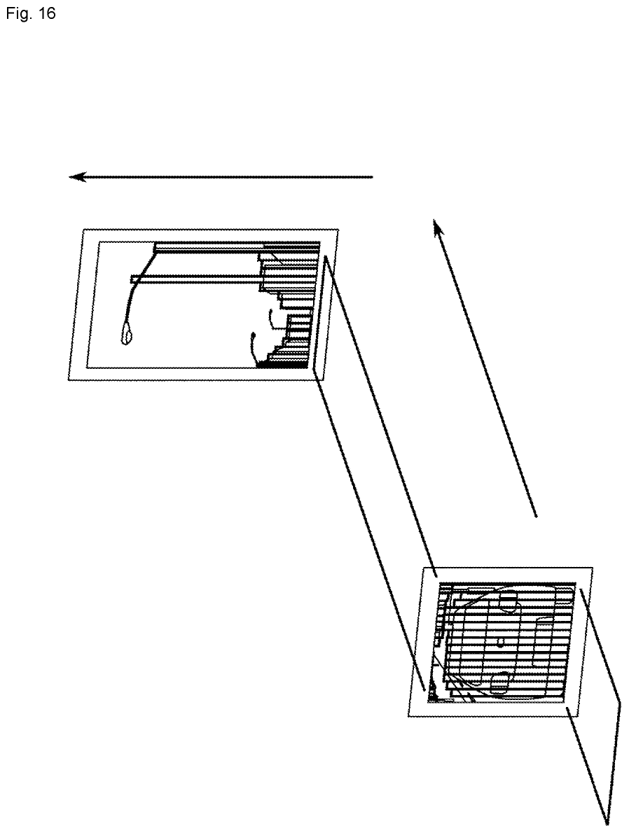

Accordingly, for example, each object region in FIG. 15 is separated into an object region including a vehicle and an object region including a group of buildings in a background, as illustrated in FIG. 16.

In the examples of FIGS. 15 and 16, the upper limit of the number of detected object regions in each unit region is set to two. Therefore, for example, the same object region may include a building and a streetlight without separation, or may include a building, a streetlight, and a space between these without separation, as illustrated in FIG. 16.

On the other hand, for example, the upper limit of the number of detected object regions in each unit region is set to 4 so that the object regions can be detected more accurately. That is, the object regions are easily separated into individual objects.

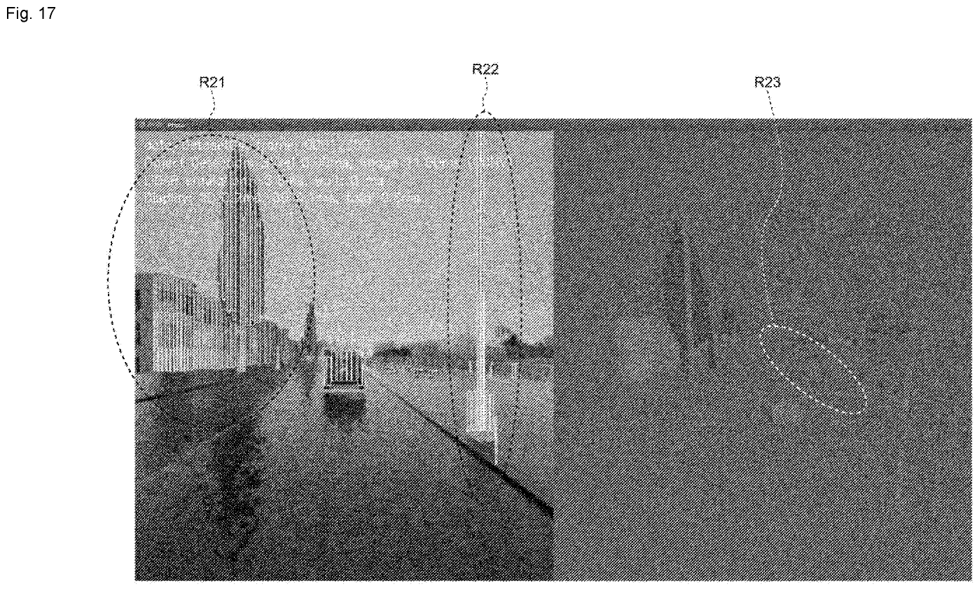

FIG. 17 illustrates an example of the result of detecting the object regions when the upper limit of the number of detected object regions in each unit region is set to four. A left diagram illustrates an example in which each object region is superimposed on a corresponding region of the captured image. A vertically long rectangular region in FIG. 17 is the object region. A right diagram illustrates an example of an image in which each object region with depth information added thereto is disposed. A length of each object region in the depth direction is obtained, for example, on the basis of distances to measurement points within each object region.

When the upper limit of the number of detected object regions in each unit region is set to 4, an object region corresponding to a tall object and an object region corresponding to a low object are easily separated, for example, as shown in regions R21 and R22 in the left diagram. Further, for example, object regions corresponding to individual distant objects are easily separated, as shown in a region R23 in the right drawing.

Next, the object region detection unit 221 detects a target object region likely to include a target object that is an object as a recognition target from among the object regions after the coupling processing, on the basis of the distribution of the measurement points in each object region.

For example, the object region detection unit 221 calculates a size (an area) of each object region on the basis of distributions in the x-axis direction and the y-axis direction of the measurement points included in each object region. Further, the object region detection unit 221 calculates a tilt angle of each object region on the basis of a range (dy) in a height direction (y-axis direction) and a range (dz) in a distance direction (z-axis direction) of the measurement points included in each object region.

The object region detection unit 221 extracts the object region having an area equal to or greater than a predetermined threshold value and the tilt angle equal to or greater than a predetermined threshold value as the target object region from among the object regions after the coupling processing. For example, when an object with which collision should be avoided in front of the vehicle is the recognition target, an object region having an area of 3 m² or more and the tilt angle of 30° or more is detected as the target object region.

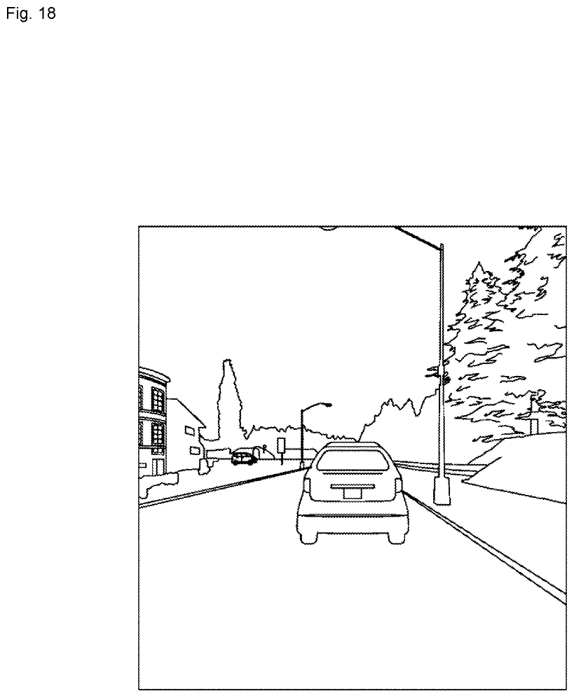

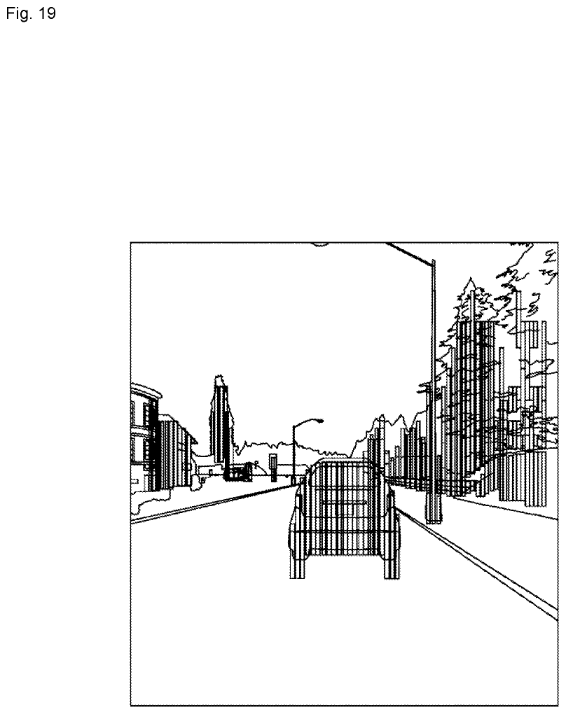

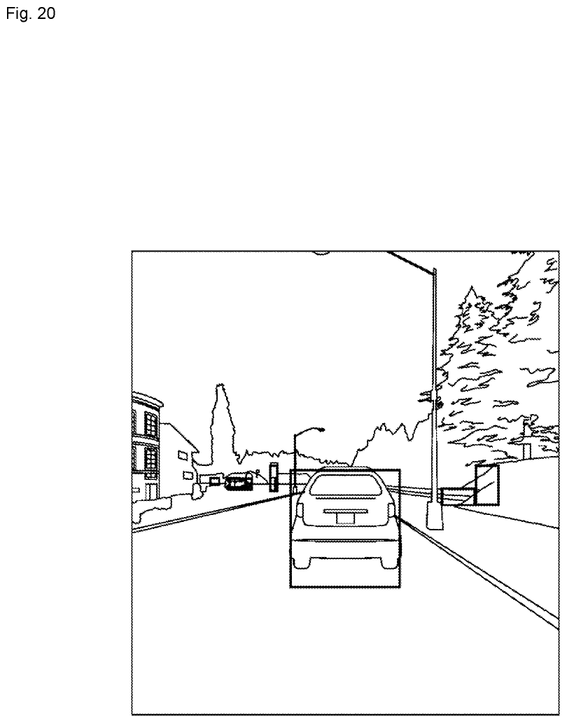

For example, the captured image schematically illustrated in FIG. 18 is associated with a rectangular object region, as illustrated in FIG. 19 After the object region coupling processing in FIG. 19 is performed, the target object region indicated by a rectangular region in FIG. 20 is detected.

The object region detection unit 221 supplies the captured image, the point cloud data, and the information indicating the detection result for the object region and the target object region to the object recognition unit 222.

Returning to FIG. 5, in step S4, the object recognition unit 222 sets a recognition range on the basis of the target object region.

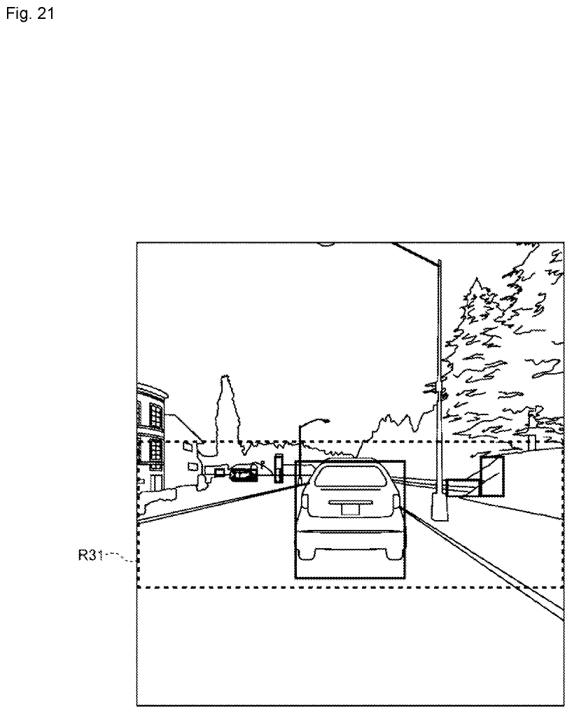

For example, as illustrated in FIG. 21, a recognition range R31 is set on the basis of a detection result of the target object region illustrated in FIG. 20. In this example, a width and height of the recognition range R31 are set to ranges obtained by adding predetermined margins to respective ranges in the horizontal direction and the vertical direction in which there is the target object region.

In step S5, the object recognition unit 222 recognizes objects within the recognition range.

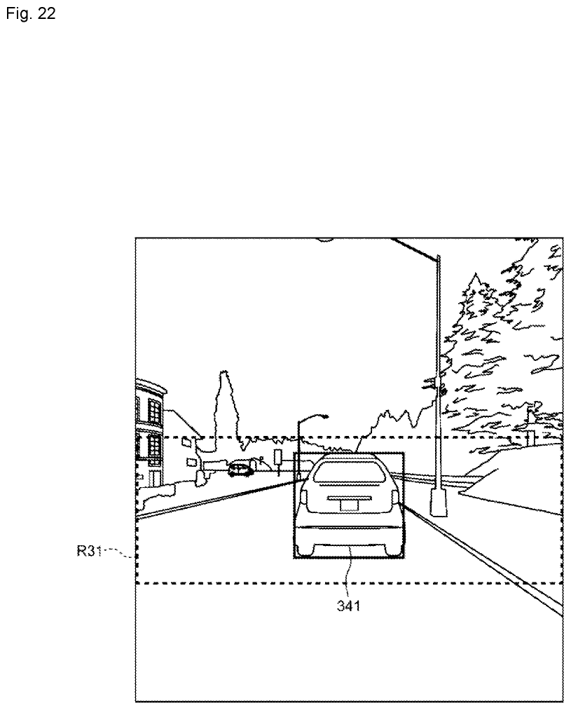

For example, when an object as a recognition target of the information processing system 201 is a vehicle in front of the vehicle 1, a vehicle 341 surrounded by a rectangular frame is recognized within the recognition range R31, as illustrated in FIG. 22.

The object recognition unit 222 supplies the captured image, the point cloud data, and information indicating the result of detecting the object region, the detection result for the target object region, the recognition range, and the recognition result for the object to the output unit 223.

In step S6, the output unit 223 outputs the result of the object recognition. Specifically, the output unit 223 generates output information indicating the result of object recognition and the like, and outputs the output information to a subsequent stage.

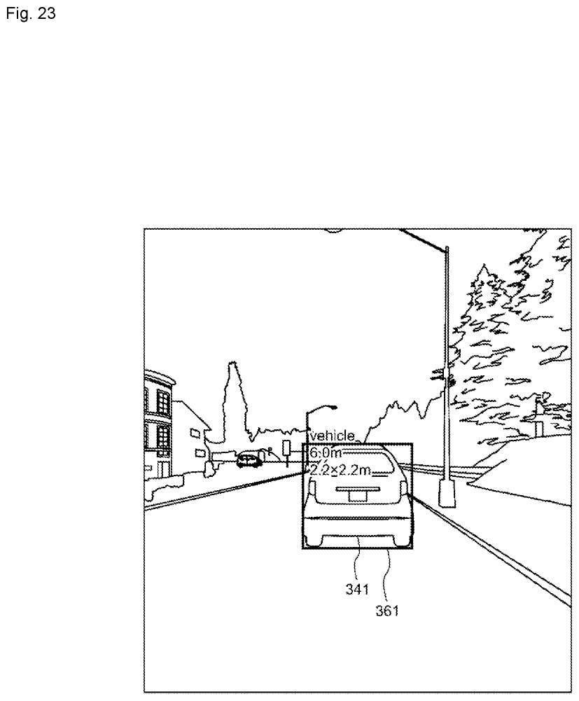

FIGS. 23 to 25 illustrate specific examples of the output information.

FIG. 23 schematically illustrates an example of the output information obtained by superimposing an object recognition result on the captured image. Specifically, a frame 361 surrounding the recognized vehicle 341 is superimposed on the captured image. Further, information (vehicle) indicating a category of the recognized vehicle 341, information (6.0 m) indicating a distance to the vehicle 341, and information (width 2.2 m×height 2.2 m) indicating a size of the vehicle 341 are superimposed on the captured image.

The distance to the vehicle 341 and the size of the vehicle 341 are calculated, for example, on the basis of the distribution of the measurement points within the target object region corresponding to the vehicle 341. The distance to the vehicle 341 is calculated, for example, on the basis of the distribution of the distances to the measurement points within the target object region corresponding to the vehicle 341. The size of the vehicle 341 is calculated, for example, on the basis of the distribution in the x-axis direction and the y-axis direction of the measurement points within the target object region corresponding to the vehicle 341.

Further, for example, only one of the distance to the vehicle 341 and the size of the vehicle 341 may be superimposed on the captured image.

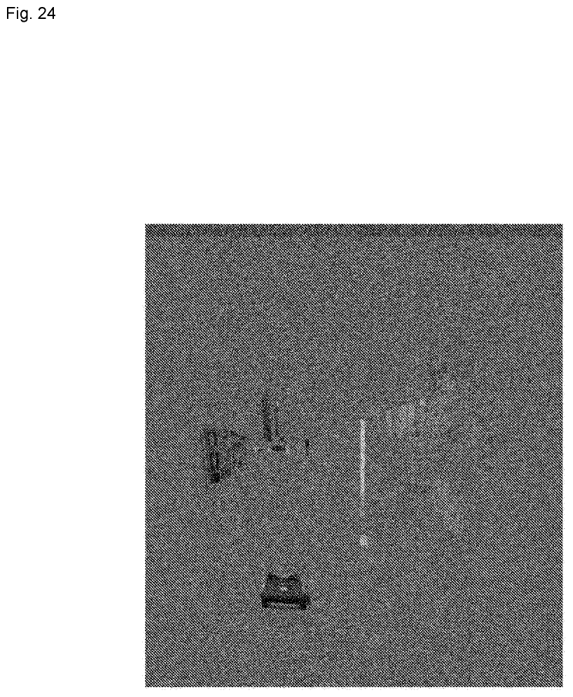

FIG. 24 illustrates an example of output information in which images corresponding to the respective object regions are two-dimensionally disposed on the basis of the distribution of the measurement points within each object region. Specifically, for example, an image of the region within the captured image corresponding to each object region is associated with each object region on the basis of a position within the virtual plane of each object region before the coupling processing. Further, positions of each object region in the azimuth direction, the elevation angle direction, and the distance direction are obtained on the basis of a direction (an azimuth and an elevation angle) of the measurement point within each object region and the distance to the measurement point. The images corresponding to the respective object regions are two-dimensionally disposed on the basis of the positions of the respective object regions, so that the output information illustrated in FIG. 24 is generated.

For example, an image corresponding to the recognized object may be displayed so that the image can be identified from other images.

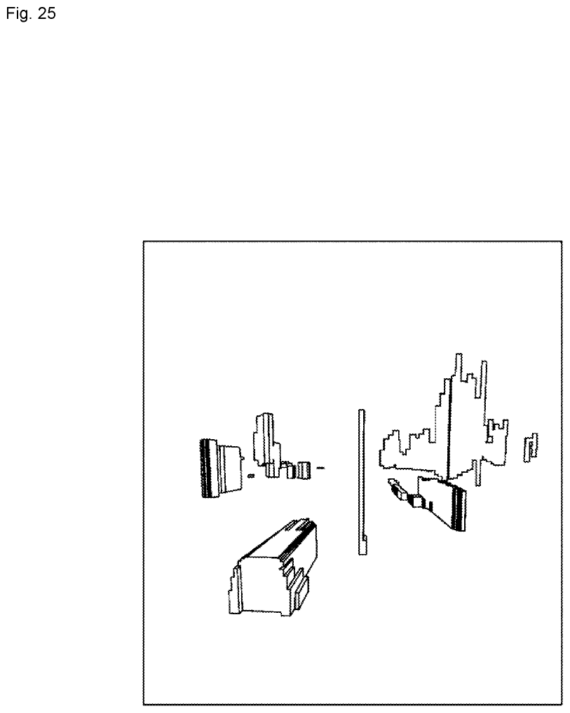

FIG. 25 illustrates an example of output information in which rectangular parallelepipeds corresponding to the respective object regions are two-dimensionally disposed on the basis of the distribution of the measurement points in each object region. Specifically, a length in the depth direction of each object region is obtained on the basis of the distance to the measurement point within each object region before the coupling processing. A length in the depth direction of each object region is calculated, for example, on the basis of a difference in distance between the measurement point closest to the vehicle 1 and the measurement point furthest from the vehicle 1 among the measurement points in each object region. Further, positions of each object region in the azimuth direction, the elevation angle direction, and the distance direction are obtained on the basis of a direction (an azimuth and an elevation angle) of the measurement point within each object region and the distance to the measurement point. Rectangular parallelepipeds indicating a width in the azimuth direction, a height in the elevation angle direction, and a length in the depth direction of the respective object regions are two-dimensionally disposed on the basis of the positions of the respective object regions, so that the output information illustrated in FIG. 25 is generated.

For example, a rectangular parallelepiped corresponding to the recognized object may be displayed so that the rectangular parallelepiped can be identified from other rectangular parallelepipeds.

Thereafter, the processing returns to step S1, and the processing after step S1 is executed.

As described above, it is possible to reduce a load of object recognition using sensor fusion.

Specifically, the scanning interval in the elevation angle direction of the LiDAR 212 is controlled on the basis of the elevation angle and the measurement points are thinned out, thereby reducing a processing load for the measurement points.

Further, the object region and the region within the captured image are associated with each other on the basis of only a positional relationship between the sensing range of the LiDAR 212 and the imaging range of the camera 211. Therefore, the load is greatly reduced as compared with a case in which the measurement point of the point cloud data is associated with a corresponding position in the captured image.

Further, the target object region is detected on the basis of the object region, and the recognition range is limited on the basis of the target object region. This reduces a load on the object recognition.

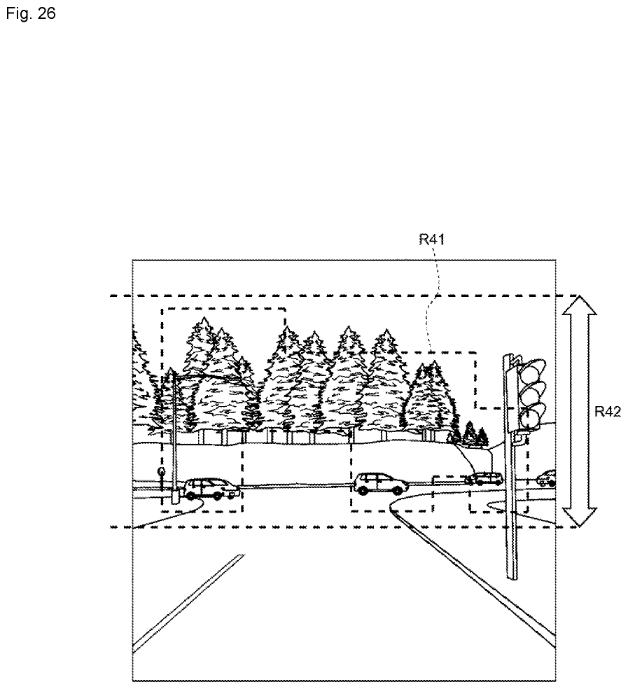

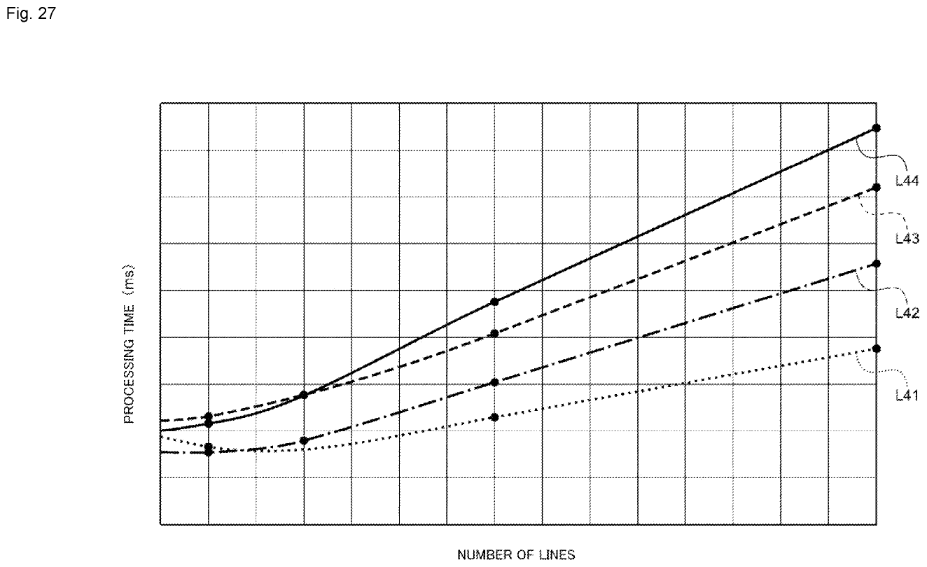

FIGS. 26 and 27 illustrate examples of a relationship between the recognition range and a processing time required for object recognition.

FIG. 26 schematically illustrates examples of the captured image and the recognition range. A recognition range R41 indicates an example of the recognition range when a range in which the object recognition is performed is limited to an arbitrary shape, on the basis of the target object region. Thus, it is also possible to set a region other than a rectangle as the recognition range. A recognition range R42 is a recognition range when the range in which object recognition is performed is limited only in a height direction of the captured image, on the basis of the target object region.

When the recognition range R41 is used, it is possible to greatly reduce the processing time required for object recognition. On the other hand, when the recognition range R42 is used, the processing time cannot be reduced as much as the recognition range R41, but the processing time can be predicted in advance according to the number of lines in the recognition range R42, and system control is facilitated.

FIG. 27 is a graph illustrating a relationship between the number of lines of the captured image included in the recognition range R42 and the processing time required for object recognition. A horizontal axis indicates the number of lines, and a vertical axis indicates the processing time (ms in unit).

Curves L41 to L44 indicate processing time when object recognition is performed using different algorithms for the recognition range in the captured image. As illustrated in this graph, when the number of lines in the recognition range R42 becomes smaller, the processing time becomes shorter regardless of a difference in algorithms in the substantially entire range.

### 3. Modification Example

Hereinafter, modification examples of the embodiment of the present technology described above will be described.

For example, it is also possible to set the object region to a shape (for example, a rectangle with rounded corners, or an ellipse) other than a rectangle).

For example, the object region may be associated with information other than the region within the captured image. For example, the object region may be associated with information (for example, pixel information or metadata) on a region corresponding to the object region in the captured image.

For example, a plurality of recognition ranges may be set within the captured image. For example, when positions of the detected target object regions are far apart, the plurality of recognition ranges may be set such that each target object region is included in any one of the recognition ranges.

Further, for example, classification of classes of the respective recognition ranges may be performed on the basis of a shape, size, position, distance, or the like of the target object region included in each recognition range, and the object recognition may be performed by using a method according to the class of each recognition range.

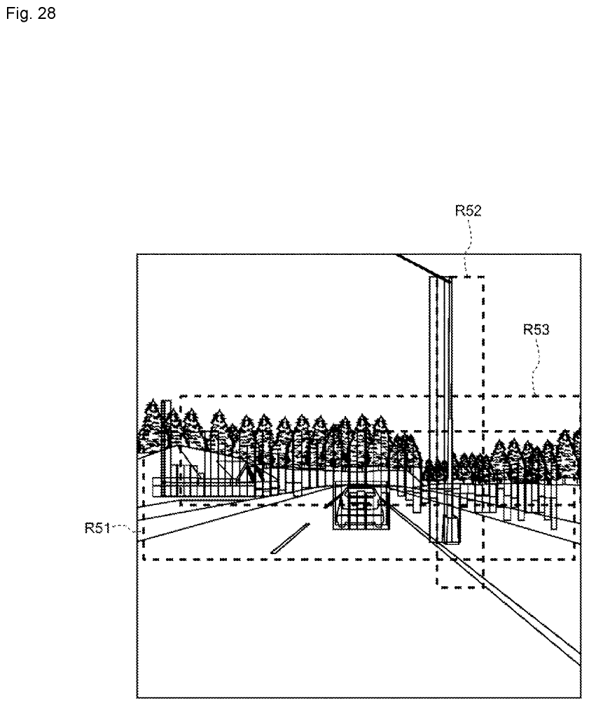

For example, in an example of FIG. 28, recognition ranges R51 to R53 are set. The recognition range R51 includes a preceding vehicle and is classified into a class requiring precise object recognition. The recognition range R52 is classified into a class including high objects such as road signs, traffic lights, street lamps, utility poles, and overpasses. The recognition range R53 is classified into a class including a region that is a distant background. An object recognition algorithm suitable for the class of each recognition range is applied to the recognition ranges R51 to R53, and object recognition is performed. This improves the accuracy or speed of the object recognition.

For example, the recognition range may be set on the basis of the object region before the coupling processing or the object region after the coupling processing without performing detection of the target object region.

For example, the object recognition may be performed on the basis of the object region before the coupling processing or the object region after the coupling processing without setting the recognition range.

A detection condition for the target object region described above is an example thereof, and can be changed according to, for example, an object as the recognition target or a purpose of object recognition.

The present technology can also be applied to a case in which object recognition is performed by using a distance measurement sensor (for example, a millimeter wave radar) other than the LiDAR 212 for sensor fusion. Further, the present technology can also be applied to a case in which object recognition is performed by using sensor fusion using three or more types of sensors.

The present technology can also be applied to a case in which not only a distance measurement sensor that performs scanning with measurement light such as laser pulses in the azimuth direction and the elevation angle direction, but also a distance measurement sensor using a scheme for emitting measurement light radially in the azimuth direction and the elevation angle direction and receiving reflected light is used.

The present technology can also be applied to object recognition for uses other than in-vehicle use described above.

For example, the present technology can be applied to a case in which objects around a mobile object other than vehicles are recognized. For example, mobile objects such as motorcycles, bicycles, personal mobility, airplanes, ships, construction machinery, and agricultural machinery (tractors) are assumed. Further, examples of the mobile object to which the present technology can be applied include mobile objects such as drones or robots that are remotely driven (operated) without being boarded by a user.

For example, the present technology can be applied to a case in which object recognition is performed at a fixed place such as a surveillance system.

### 4. Others

<Example of Configuration of Computer>

The series of processing described above can be executed by hardware or can be executed by software. When the series of processing is executed by software, a program that constitutes the software is installed in the computer. Here, the computer includes, for example, a computer built into dedicated hardware, or a general-purpose personal computer capable of executing various functions by various programs being installed.

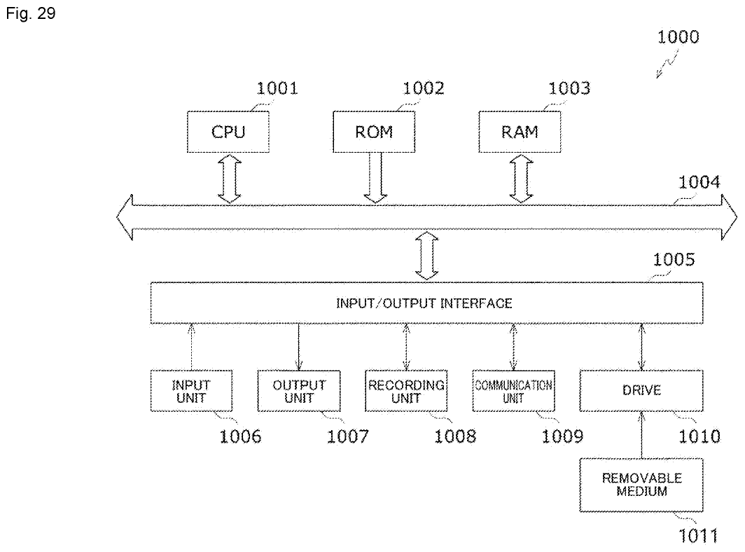

FIG. 29 is a block diagram illustrating a configuration example of hardware of a computer that executes the series of processing described above using a program.

In a computer 1000, a central processing unit (CPU) 1001, a read only memory (ROM) 1002, and a random access memory (RAM) 1003 are interconnected by a bus 1004.

An input and output interface 1005 is further connected to the bus 1004. An input unit 1006, an output unit 1007, a recording unit 1008, a communication unit 1009 and a drive 1010 are connected to the input and output interface 1005.

The input unit 1006 includes input switches, buttons, a microphone, an imaging device, or the like. The output unit 1007 includes a display, a speaker, or the like. The recording unit 1008 includes a hard disk, a nonvolatile memory, or the like. The communication unit 1009 includes a network interface or the like. The drive 1010 drives a removable medium 1011 such as a magnetic disk, optical disc, magneto-optical disc, or semiconductor memory.

In the computer 1000 configured as described above, the CPU 1001 loads, for example, a program recorded in the recording unit 1008 into the RAM 1003 via the input and output interface 1005 and the bus 1004, and executes the program so that the series of processing described above are performed.

A program executed by the computer 1000 (the CPU 1001) can be provided by being recorded on the removable medium 1011 such as a package medium, for example. Further, the program can be provided via a wired or wireless transmission medium such as a local area network, the Internet, or digital satellite broadcasting.

In the computer 1000, the program can be installed in the recording unit 1008 via the input and output interface 1005 by the removable medium 1011 being mounted in the drive 1010. Further, the program can be received by the communication unit 1009 via the wired or wireless transmission medium and installed in the recording unit 1008. Further, the program can be installed in the ROM 1002 or the recording unit 1008 in advance.

The program executed by the computer may be a program that is processed in chronological order in an order described in the present specification, or may be a program in which processing is performed in parallel or at a necessary timing such as when a call is made.

Further, in the present specification, the system means a set of a plurality of components (devices, modules (parts), or the like), and it does not matter whether or not all the components are in the same housing. Therefore, a plurality of devices housed in separate housings and connected via a network, and one device housing a plurality of modules in one housing, are both systems.

Further, the embodiments of the present technology are not limited to the above-described embodiments, and various changes can be made without departing from the gist of the present technology.

For example, the present technology can have a configuration of cloud computing in which one function is shared and processed by a plurality of devices via a network.

Further, the respective steps described in the flowchart described above can be executed by one device or can be shared and executed by a plurality of devices.

Further, when one step includes a plurality of processing, the plurality of processing included in the one step can be executed by one device or may be shared and executed by a plurality of devices.

<Example of Combination of Configuration>

The present technology can also have the following configurations.

(1)

An information processing device including: an object region detection unit configured to detect an object region indicating ranges in an azimuth direction and an elevation angle direction in which there is an object within a sensing range of the distance measurement sensor on the basis of three-dimensional data indicating a direction of and a distance to each measurement point measured by a distance measurement sensor, and associate information within a captured image captured by a camera whose imaging range at least partially overlaps the sensing range with the object region.

(2)

The information processing device according to (1), wherein the object region detection unit detects the object region indicating the range in the elevation angle direction in which there is an object, for each unit region obtained by dividing the sensing range in the azimuth direction.

(3)

The information processing device according to (2), wherein the object region detection unit is capable of detecting the number of object regions equal to or smaller than a predetermined upper limit in each unit region.

(4)

The information processing device according to (2) or (3), wherein the object region detection unit detects the object region on the basis of distributions of elevation angles of and distances to the measurement points within the unit region.

(5)

The information processing device according to any one of (1) to (4), further including: an object recognition unit configured to perform object recognition on the basis of the captured image and a result of detecting the object region.

(6)

The information processing device according to (5), wherein the object recognition unit sets a recognition range in which object recognition is performed in the captured image, on the basis of the result of detecting the object region, and performs the object recognition within the recognition range.

(7)

The information processing device according to (6),

wherein the object region detection unit performs coupling processing on the object regions on the basis of relative positions between the object regions and distances to the measurement points included in each object region, and detects a target object region in which a target object as a recognition target is likely to be present on the basis of the object region after the coupling processing, and

the object recognition unit sets the recognition range on the basis of a detection result for the target object region.

(8)

The information processing device according to (7), wherein the object region detection unit detects the target object region on the basis of a distribution of the measurement points in each object region after the coupling processing.

(9)

The information processing device according to (8), wherein the object region detection unit calculates a size and tilt angle of each object region on the basis of the distribution of the measurement points in each object region after coupling processing, and detects the target object region on the basis of the size and tilt angle of each object region.

(10)

The information processing device according to any one of (7) to (9), wherein the object recognition unit performs class classification of the recognition range on the basis of the target object region included in the recognition range, and performs object recognition by using a method according to the class of the recognition range.

(11)

The information processing device according to any one of (7) to (10), wherein the object region detection unit further includes an output unit configured to calculate at least one of a size and a distance of the recognized object on the basis of a distribution of the measurement points within the target object region corresponding to the recognized object, and generate output information in which at least one of the size and distance of the recognized object is superimposed on the captured image.

(12)

The information processing device according to any one of (1) to (10), further including:

an output unit configured to generate output information in which images corresponding to respective object regions are two-dimensionally disposed on the basis of the distribution of the measurement points in the respective object regions.

(13)

The information processing device according to any one of (1) to (10), further including:

an output unit configured to generate output information in which rectangular parallelepipeds corresponding to respective object regions are two-dimensionally disposed on the basis of the distribution of the measurement points in the respective object regions.

(14)

The information processing device according to any one of (1) to (6), wherein the object region detection unit performs coupling processing on the object regions on the basis of relative positions between the object regions and the distances to the measurement points included in each object region.

(15)

The information processing device according to (14), wherein the object region detection unit detects a target object region in which an object as a recognition target is likely to be present, on the basis of the distribution of the measurement points in each object region after the coupling processing.

(16)

The information processing device according to any one of (1) to (15), further including:

a scanning control unit configured to control a scanning interval in the elevation angle direction of the distance measurement sensor on the basis of an elevation angle of the sensing range.

(17)

The information processing device according to (16),

wherein the distance measurement sensor performs sensing of a region in front of a vehicle, and

the scanning control unit decreases the scanning interval in the elevation angle direction of the distance measurement sensor when a scanning direction in the elevation angle direction of the distance measurement sensor is closer to an angle at which a position a predetermined distance away from the vehicle on a horizontal road surface in front of the vehicle is irradiated with measurement light of the distance measurement sensor.

(18)

The information processing device according to (16),

wherein the distance measurement sensor performs sensing of a region in front of a vehicle, and

the scanning control unit controls the scanning interval in the elevation angle direction of the distance measurement sensor so that a scanning interval in a distance direction with respect to a horizontal road surface in front of the vehicle is an equal interval.

(19)

An information processing method including:

detecting an object region indicating ranges in an azimuth direction and an elevation angle direction in which there is an object within a sensing range of a distance measurement sensor on the basis of three-dimensional data indicating a direction of and a distance to each measurement point measured by the distance measurement sensor, and associating information within a captured image captured by a camera whose imaging range at least partially overlaps the sensing range with the object region.

(20)

A program for causing a computer to execute processing for:

detecting an object region indicating ranges in an azimuth direction and an elevation angle direction in which there is an object within a sensing range of a distance measurement sensor on the basis of three-dimensional data indicating a direction of and a distance to each measurement point measured by the distance measurement sensor, and associating information within a captured image captured by a camera whose imaging range at least partially overlaps the sensing range with the object region.

The effects described in the present specification are merely examples and are not limited, and there may be other effects.

### REFERENCE SIGNS LIST

1 Vehicle
11 Vehicle control system
32 Vehicle control unit
51 Camera
53 LiDAR
72 Sensor fusion unit
73 Recognition unit
201 Information processing system
211 Camera
212 LiDAR
213 Information processing unit
221 Object region detection unit
222 Object recognition unit
223 Output unit
224 Scanning control unit

1. An information processing device comprising:
an object region detection unit configured to detect an object region indicating ranges in an azimuth direction and an elevation angle direction in which there is an object within a sensing range of a distance measurement sensor on the basis of three-dimensional data indicating a direction of and a distance to each measurement point measured by the distance measurement sensor, and associate information within a captured image captured by a camera whose imaging range at least partially overlaps the sensing range with the object region.

2. The information processing device according to claim 1, wherein the object region detection unit detects the object region indicating the range in the elevation angle direction in which there is an object, for each unit region obtained by dividing the sensing range in the azimuth direction.

3. The information processing device according to claim 2, wherein the object region detection unit is capable of detecting the number of object regions equal to or smaller than a predetermined upper limit in each unit region.

4. The information processing device according to claim 2, wherein the object region detection unit detects the object region on the basis of distributions of elevation angles of and distances to the measurement points within the unit region.

5. The information processing device according to claim 1, further comprising: an object recognition unit configured to perform object recognition on the basis of the captured image and a result of detecting the object region.

6. The information processing device according to claim 5, wherein the object recognition unit sets a recognition range in which object recognition is performed in the captured image, on the basis of the result of detecting the object region, and performs the object recognition within the recognition range.

7. The information processing device according to claim 6,
wherein the object region detection unit performs coupling processing on the object regions on the basis of relative positions between the object regions and distances to the measurement points included in each object region, and detects a target object region in which a target object as a recognition target is likely to be present on the basis of the object region after the coupling processing, and
the object recognition unit sets the recognition range on the basis of a detection result for the target object region.

8. The information processing device according to claim 7, wherein the object region detection unit detects the target object region on the basis of a distribution of the measurement points in each object region after the coupling processing.

9. The information processing device according to claim 8, wherein the object region detection unit calculates a size and tilt angle of each object region on the basis of the distribution of the measurement points in each object region after coupling processing, and detects the target object region on the basis of the size and tilt angle of each object region.

10. The information processing device according to claim 7, wherein the object recognition unit performs class classification of the recognition range on the basis of the target object region included in the recognition range, and performs object recognition by using a method according to the class of the recognition range.

11. The information processing device according to claim 7, wherein the object region detection unit further includes an output unit configured to
calculate at least one of a size and a distance of the recognized object on the basis of a distribution of the measurement points within the target object region corresponding to the recognized object, and
generate output information in which at least one of the size and distance of the recognized object is superimposed on the captured image.

12. The information processing device according to claim 1, further comprising:
an output unit configured to generate output information in which images corresponding to respective object regions are two-dimensionally disposed on the basis of the distribution of the measurement points in the respective object regions.

13. The information processing device according to claim 1, further comprising:
an output unit configured to generate output information in which rectangular parallelepipeds corresponding to respective object regions are two-dimensionally disposed on the basis of the distribution of the measurement points in the respective object regions.

14. The information processing device according to claim 1, wherein the object region detection unit performs coupling processing on the object regions on the basis of relative positions between the object regions and the distances to the measurement points included in each object region.

15. The information processing device according to claim 14, wherein the object region detection unit detects a target object region in which an object as a recognition target is likely to be present, on the basis of the distribution of the measurement points in each object region after the coupling processing.

16. The information processing device according to claim 1, further comprising:
a scanning control unit configured to control a scanning interval in the elevation angle direction of the distance measurement sensor on the basis of an elevation angle of the sensing range.

17. The information processing device according to claim 16,
wherein the distance measurement sensor performs sensing of a region in front of a vehicle, and
the scanning control unit decreases the scanning interval in the elevation angle direction of the distance measurement sensor when a scanning direction in the elevation angle direction of the distance measurement sensor is closer to an angle at which a position a predetermined distance away from the vehicle on a horizontal road surface in front of the vehicle is irradiated with measurement light of the distance measurement sensor.

18. The information processing device according to claim 16,
wherein the distance measurement sensor performs sensing of a region in front of a vehicle, and
the scanning control unit controls the scanning interval in the elevation angle direction of the distance measurement sensor so that a scanning interval in a distance direction with respect to a horizontal road surface in front of the vehicle is an equal interval.

19. An information processing method comprising:
detecting an object region indicating ranges in an azimuth direction and an elevation angle direction in which there is an object within a sensing range of a distance measurement sensor on the basis of three-dimensional data indicating a direction of and a distance to each measurement point measured by the distance measurement sensor, and associating information within a captured image captured by a camera whose imaging range at least partially overlaps the sensing range with the object region.

20. A program for causing a computer to execute processing for:
detecting an object region indicating ranges in an azimuth direction and an elevation angle direction in which there is an object within a sensing range of a distance measurement sensor on the basis of three-dimensional data indicating a direction of and a distance to each measurement point measured by the distance measurement sensor, and associating information within a captured image captured by a camera whose imaging range at least partially overlaps the sensing range with the object region.
